(19) United States
(12) Patent Application Publication
(10) Pub. No.: US 2008/0080587 A1
(43) Pub. Date: Apr. 3, 2008

(54) Method and apparatus for measuring the recording magnetic field strength distribution of a magnetic head and method of manufacturing a magnetic head

(75) Inventor: Akihiro Inomata, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/656,561

(22) Filed: Jan. 23, 2007

(30) Foreign Application Priority Data
Sep. 29, 2006 (JP) 2006-269638

(51) Int. Cl. G01N 25/00; G11B 5/127

(52) U.S. Cl. 374/45; 360/110

(57) ABSTRACT

A method of measuring the recording magnetic field strength distribution of a magnetic head having a recording element is disclosed that includes the steps of: (a) disposing the magnetic head above a measurement medium having a recording layer; (b) heating a partial area of the recording layer opposing the medium-opposing surface of the recording element, and generating a recording magnetic field to emanate therefrom; (c) measuring the reproduction output of a magnetic track in the partial area; (d) repeating steps (b) and (c) while changing the partial area to be heated; and (e) converting the reproduction outputs into the recording magnetic field strength distribution. The coercive force of the measurement medium is reduced by the heating; and step (b) heats the partial area to a temperature at which the coercive force is lower than the strength of the magnetic field applied to the partial area.

### CROSS-REFERENCE TO RELATED APPLICATION

The present application is based on Japanese Priority Patent Application No. 2006-269638, filed on Sep. 29, 2006, the entire contents of which are hereby incorporated by reference.

### BACKGROUND OF THE INVENTION

1. Field of the Invention

The present invention relates generally to a method and apparatus for measuring the recording magnetic field strength distribution of a magnetic head, and a method of manufacturing a magnetic head.

2. Description of the Related Art

As magnetic storage units have become higher in recording density, magnetic recording media have improved in signal-to-noise (S/N) ratio and the long-term stability of recorded information. On the other hand, various technological innovations have been made on magnetic heads that perform recording on and reproduction from magnetic recording media as the recording density has become higher. As reproduction elements, magnetoresistive (MR) elements having a spin-valve structure and tunneling magnetoresistance (TMR) elements have been employed so as to increase output and improve the S/N ratio. Further, recording elements are required to generate a recording magnetic field of a sharp and high magnetic field strength in a narrow area in order to perform recording on a magnetic recording medium of high coercivity with a track width of approximately 200 nm or less. Designing such recording elements is performed with the help of computerized magnetic field calculation to obtain the strength (intensity) distribution of a recording magnetic field.

However, even if a desired recording magnetic field strength distribution is obtained by magnetic field calculation, desired recording characteristics may not be obtained in the actually manufactured magnetic head. For example, demagnetization of an adjacent track by repeatedly performing recording on a predetermined track, so-called off-track erasure, may occur. Further, sufficient output or non-linear transition shift (NLTS) characteristics may not be obtained at a desired recording density. These are attributed to generation of an abnormal magnetic field due to processing error of the magnetic head or a change in the magnetic field strength distribution due to magnetization of a magnetic recording medium. In these cases, it is necessary to actually measure the recording magnetic field of the magnetic head.

As a technique for directly measuring the recording magnetic field of a magnetic head, for example, Japanese Laid-Open Patent Application No. 3-138581 (Patent Document-1) proposes a technique using the phenomenon where an electron beam is deflected by a recording magnetic field. Japanese Laid-Open Patent Application No. 2000-180522 (Patent Document 2) proposes a technique that uses a thin film showing a magneto-optical effect as a magnetic field detection element and measures the magnetic field strength applied to the thin film by the polarizing angle of light passing through the thin film. Japanese Laid-Open Patent Application No. 5-128448 (Patent Document 3) proposes a technique that performs recording on a magnetic recording medium of a known saturation recording magnetic field with a magnetic head and indirectly measures the recording magnetic field strength of the magnetic head from the relationship between a recording current and the saturation magnetic field.

However, the above-described electron beam technique of Patent Document 1, which requires large-scale equipment, cannot be used easily and is difficult to introduce in a magnetic head manufacturing process as a testing device in terms of cost. Further, the technique of Patent Document 3 has a problem in that the method of measuring the recording magnetic field of a magnetic head is complicated and it is difficult to determine the distribution of the recording magnetic field strength with accuracy.

### SUMMARY OF THE INVENTION

Embodiments of the present invention may solve or reduce one or more of the above-described problems.

According to one embodiment of the present invention, there are provided a method and apparatus for measuring the recording magnetic field strength distribution of a magnetic head and a method of manufacturing a magnetic head in which one or more of the above-described problems are solved or reduced.

According to one embodiment of the present invention, there are provided a method and apparatus for measuring the recording magnetic field strength distribution of a magnetic head and a method of manufacturing a magnetic head that can measure the recording magnetic field strength distribution of the magnetic head with ease and good measurement accuracy.

According to one embodiment of the present invention, there is provided a method of measuring a recording magnetic field strength distribution of a magnetic head having a recording element, the method including the steps of: (a) disposing the magnetic head at a distance from and above a measurement medium having a recording layer; (b) heating one of partial areas of the recording layer which areas oppose a medium-opposing surface of the recording element, and generating a recording magnetic field to emanate from the recording element by supplying a predetermined recording current to the recording element; (c) measuring a reproduction output of a magnetic track formed in the one of the partial areas; (d) repeating steps (b) and (c) while changing the one of the partial areas to be heated; and (e) converting the reproduction outputs obtained for the partial areas into the recording magnetic field strength distribution, wherein the one of the partial areas corresponds to a part of the medium-opposing surface of the recording element; a coercive force of the measurement medium is reduced by the heating; and step (b) heats the one of the partial areas of the recording layer to a temperature at which the coercive force of the measurement medium is lower than a strength of the magnetic field applied to the one of the partial areas from the magnetic head.

According to one embodiment of the present invention, a measurement medium is employed which, at room temperature, has a coercive force higher than the maximum recording magnetic field strength of a magnetic head to be subjected to measurement at a predetermined recording current. Then, a partial area of the recording layer of the measurement medium corresponding to a part of the medium-opposing surface of the recording element of the magnetic head is heated, so that the coercive force of the recording layer is lower in the heated area than in the other area of the recording layer. As a result, only the heated partial area is magnetized with a recording magnetic field from the magnetic head, so that a magnetic track is formed therein. The reproduction output of the magnetic track is measured and converted into magnetic field strength, so that the magnetic field strength of the recording magnetic field can be detected. Further, by measuring the reproduction output corresponding to multiple laser light exposure positions while changing the position to be exposed to laser light, it is possible to determine the recording magnetic field strength distribution of the magnetic head. Accordingly, it is possible to measure magnetic field strength distribution with a simple method.

According to one embodiment of the present invention, there is provided an apparatus for measuring a recording magnetic field strength distribution of a magnetic head having a recording element, the apparatus including: a positioning part configured to position the magnetic head; a measurement medium having a substrate and a recording layer on the substrate; a heating part configured to heat the measurement medium and be capable of scanning positions to be heated; a recording part configured to form a magnetic track in the recording layer by causing the recording element to generate a recording magnetic field with one of partial areas of the recording layer corresponding to a part of a medium-opposing surface of the recording element being heated to a predetermined temperature with the heating part; a reproduction output measurement part configured to measure a reproduction output of the magnetic track; and an operation part configured to convert the reproduction output into a recording magnetic field strength, wherein a coercive force of the measurement medium is reduced by the heating; and the coercive force of the measurement medium is lower than a strength of the magnetic field applied to the one of the partial areas from the magnetic head at the predetermined temperature.

According to one embodiment of the present invention, it is possible to provide a measurement apparatus capable of performing the above-described method of measuring the recording magnetic field strength distribution of a magnetic head.

According to one embodiment of the present invention, there is provided a method of manufacturing a magnetic head having a recording element, the method including a test process of testing the magnetic head, wherein the test process includes the steps of: (a) disposing the magnetic head at a distance from and above a measurement medium having a recording layer; (b) heating one of partial areas of the recording layer which areas oppose a medium-opposing surface of the recording element, and generating a recording magnetic field to emanate from the recording element by supplying a predetermined recording current to the recording element; (c) measuring a reproduction output of a magnetic track formed in the one of the partial areas; (d) repeating steps (b) and (c) while changing the one of the partial areas to be heated; (e) converting the reproduction outputs obtained for the partial areas into the recording magnetic field strength distribution; and (f) comparing positions at which the recording magnetic fields are generated or recording magnetic field strengths at the positions with a predetermined range, and determining the magnetic head as an acceptable product if the positions at which the recording magnetic fields are generated or the recording magnetic field strengths at the positions are within the predetermined range and determining the magnetic head as a defective product if the positions at which the recording magnetic fields are generated or the recording magnetic field strengths at the positions are out of the predetermined range, wherein the one of the partial areas corresponds to a part of the medium-opposing surface of the recording element; a coercive force of the measurement medium is reduced by the heating; and step (b) heats the one of the partial areas of the recording layer to a temperature at which the coercive force of the measurement medium is lower than a strength of the magnetic field applied to the one of the partial areas from the magnetic head.

According to one embodiment of the present invention, it is possible to provide a method of manufacturing a magnetic head which method can detect the recording magnetic field strength distribution of a magnetic head to be subjected to measurement with a simple method without damaging the magnetic head.

Thus, according to embodiments of the present invention, it is possible to provide a method and apparatus for measuring the recording magnetic field strength distribution of a magnetic head and a method of manufacturing a magnetic head that can measure the recording magnetic field strength distribution of the magnetic head with ease and good measurement accuracy.

### BRIEF DESCRIPTION OF THE DRAWINGS

Other objects, features and advantages of the present invention will become more apparent from the following detailed description when read in conjunction with the accompanying drawings, in which:

FIG. 1 is a schematic diagram showing an apparatus for measuring the magnetic field strength distribution of a magnetic head according to a first embodiment of the present invention;

FIG. 2 is a perspective view of the magnetic head according to the first embodiment of the present invention;

FIG. 3 is a schematic diagram showing part of a medium-opposing surface of an element part of the magnetic head shown in FIG. 2 according to the first embodiment of the present invention;

FIG. 4 is a diagram for illustrating a method of measuring the magnetic field strength distribution of the magnetic head according to the first embodiment of the present invention;

FIG. 5 is a graph for illustrating measurement principles according to the first embodiment of the present invention;

FIG. 6 is a flowchart showing a method of measuring the magnetic field strength distribution of the magnetic head according to the first embodiment of the present invention;

FIG. 7 is a diagram for illustrating a laser light exposure position according to an example implementation according to the first embodiment of the present invention;

FIG. 8A is a graph showing reproduction output at the laser light exposure position of the example implementation according to the first embodiment of the present invention;

FIG. 8B is a graph showing the reproduction output of FIG. 8A around a reproduction element according to the first embodiment of the present invention;

FIG. 9 is a flowchart showing a method of measuring the position of the magnetic sensing part of the reproduction element according to the first embodiment of the present invention;

FIG. 10 is a diagram for illustrating principles of measuring the position of the magnetic sensing part of the reproduction element according to the first embodiment of the present invention;

FIG. 11 is a graph showing a measurement around the magnetic sensing part of the reproduction element according to the first embodiment of the present invention;

FIG. 12 is a diagram for illustrating a recording magnetic field of a perpendicular recording magnetic head according to the first embodiment of the present invention;

FIG. 13 is a diagram for illustrating a method of measuring the magnetic field strength distribution of the perpendicular recording magnetic head according to the first embodiment of the present invention;

FIG. 14 is a flowchart showing a method of measuring the magnetic field strength distribution of a magnetic head according to a second embodiment of the present invention; and

FIG. 15 is a graph showing the relationship between reproduction output and laser power according to the second embodiment of the present invention.

### DETAILED DESCRIPTION OF THE PREFERRED EMBODIMENTS

A description is given, with reference to the accompanying drawings, of embodiments of the present invention.

In this specification, the term “recording magnetic field” includes not only a magnetic field serving for recording generated around the magnetic gap part of a recording element but also a magnetic field generated in the area other than around the magnetic gap part, or a so-called leakage magnetic field, unless otherwise noted.

### First Embodiment

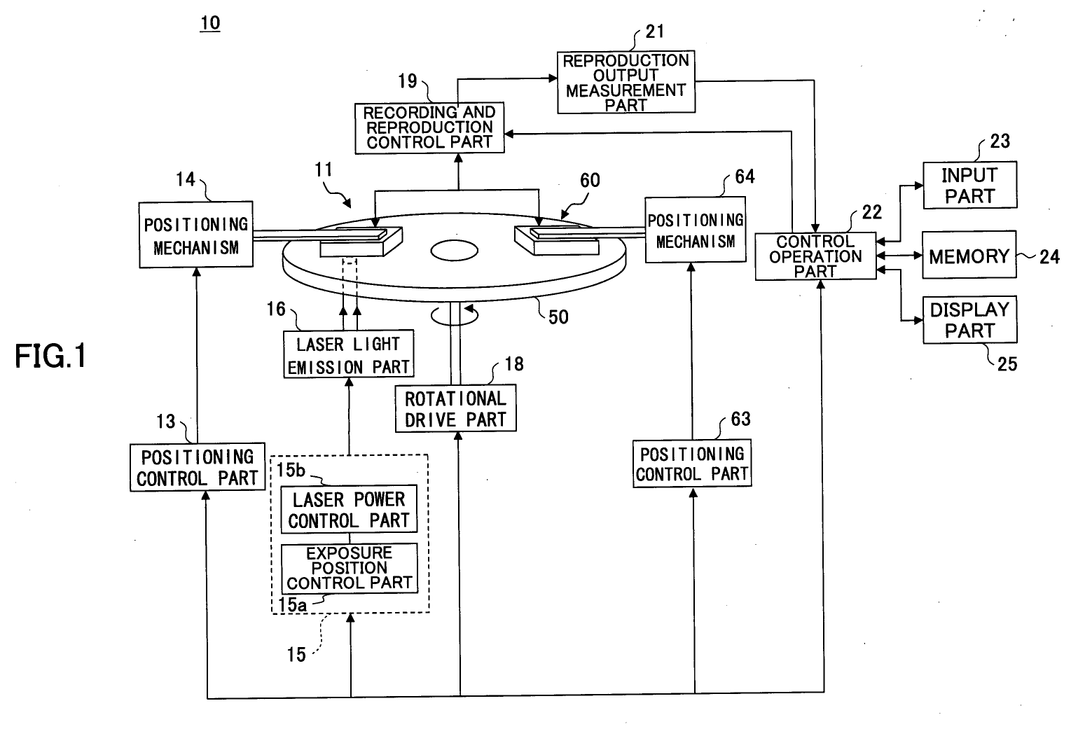

FIG. 1 is a schematic diagram showing an apparatus for measuring the magnetic field strength distribution of a magnetic head (magnetic head magnetic field strength distribution measurement apparatus) 10 according to a first embodiment of the present invention.

Referring to FIG. 1, the magnetic head magnetic field strength distribution measurement apparatus 10 includes a measurement medium 50 for measurement, a magnetic head 11 to be subjected to measurement of a magnetic field strength distribution, a positioning mechanism 14 that positions the magnetic head 11, a positioning control part 13 that controls the positioning mechanism 14, a laser light emission part 16 that emits laser light onto the measurement medium 50, an emission control part 15 that controls the laser light emission part 16, a reproduction (read) head 60 that reproduces a track profile recorded by the magnetic head 11, a positioning mechanism 64 that positions the reproduction head 60, a positioning control part 63 that controls the positioning mechanism 64, a recording and reproduction control part 19 that causes the magnetic head 11 and the reproduction head 60 to perform recording and reproduction, respectively, a reproduction output measurement part 21, a rotational drive part 18 that rotates the measurement medium 50, a control operation part 22 that controls the entire measurement apparatus 10, an input part 23 of the control operation part 22, a memory 24, and a display part 25.

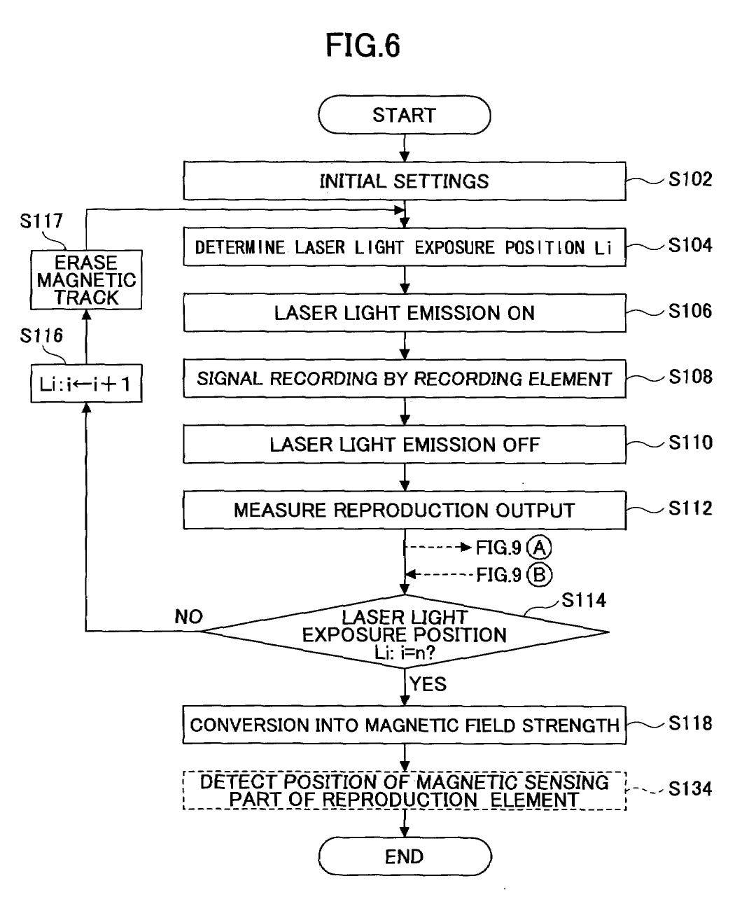

The measurement apparatus 10 operates in accordance with a program stored in the memory 24 or a command input from the input part 23, and measures the recording magnetic field strength distribution of the magnetic head 11. The program causes the measurement apparatus 10 to execute the steps of a flowchart shown in FIG. 6. First, a description is given of the magnetic head 11, which is an object of measurement.

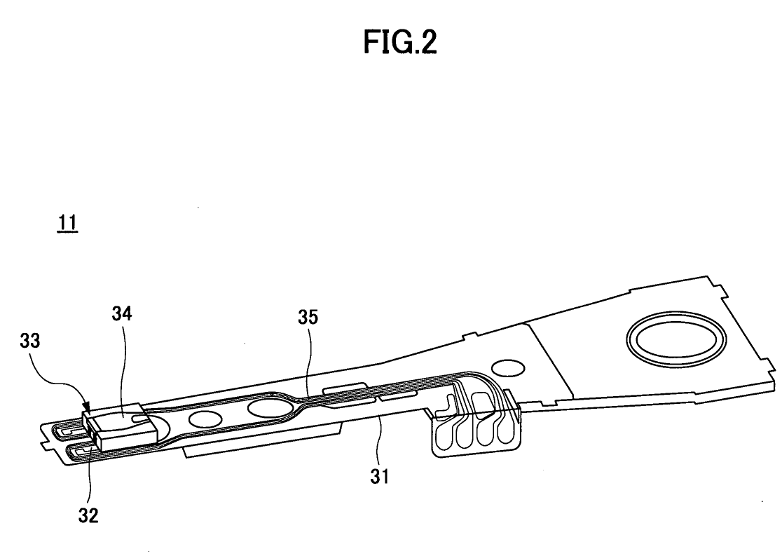

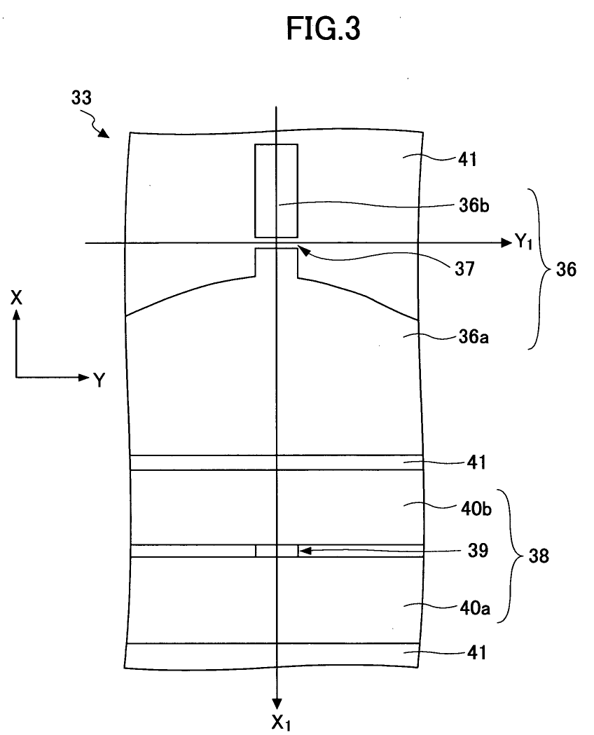

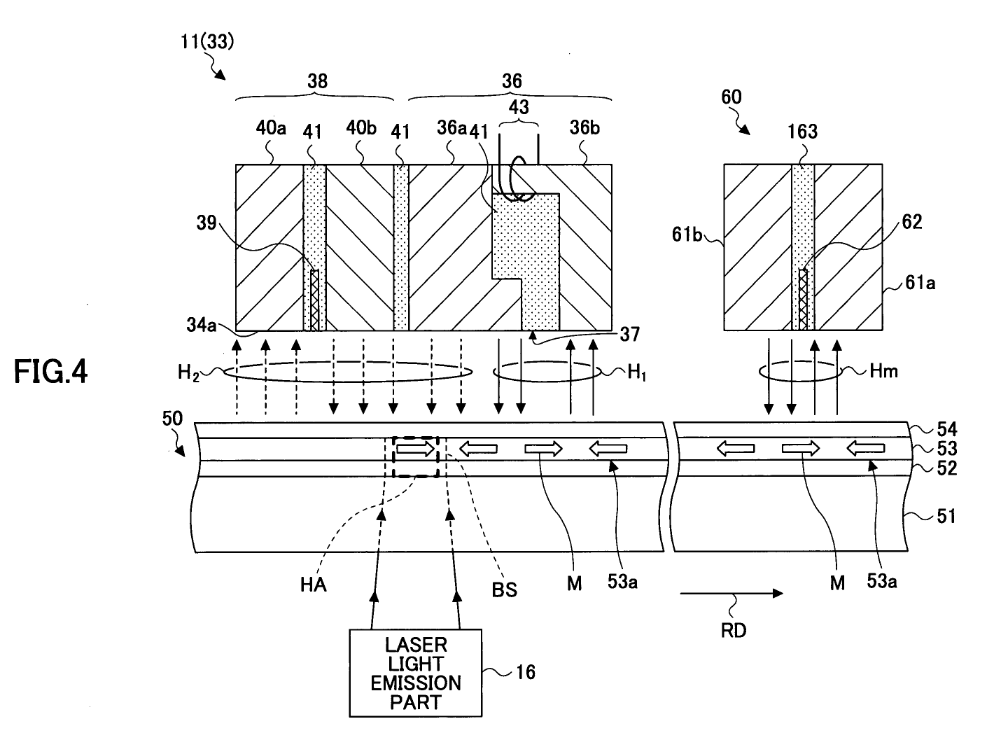

FIG. 2 is a perspective view of the magnetic head 11 according to this embodiment. FIG. 3 is a schematic diagram showing part of a medium-opposing surface 34a (FIG. 4) of a head slider 34 of the magnetic head 11 shown in FIG. 2. The medium-opposing surface refers to a surface that opposes the measurement medium 50. The directions along the X-axis shown in FIG. 3 are referred to as recording element longitudinal directions, and the directions along the Y-axis shown in FIG. 3 are referred to as recording element width directions or simply as element width directions. The recording element longitudinal directions are usually directions in which the layers of a recording element and a reproduction element are stacked.

Referring to FIGS. 2 and 3 together with FIG. 1, the magnetic head 11 includes a suspension 31 formed of a plate-like metal material, gimbals 32 engaged with the end part of the suspension 31, and the head slider 34 fixed to the gimbals 32. The head slider 34 has an element part 33 including a recording element 36 and a reproduction element 38. Further, signal interconnection lines 35 that connect the recording element 36 and the reproduction element 38 to the recording and reproduction control part 19 so as to have recording and reproduction signals transmitted therethrough are provided on the suspension 31.

The suspension 31 has its base fixed to the positioning mechanism 14 of the measurement apparatus 10. The head slider 34 is caused to fly over the measurement medium 50 by the air bearing generated between the medium-opposing surface 34a of the head slider 34 and the surface of the measurement medium 50 by the rotation of the measurement medium 50.

As shown in FIG. 3, the element part 33 of the magnetic head 11 includes the recording element 36 and the reproduction element 38. The reproduction element 38 includes lower and upper shield layers 40a and 40b each formed of a soft magnetic material and a magnetoresistive film 39 sandwiched between the shield layers 40a and 40b. The magnetoresistive film 39 serves as a magnetic sensing part. The magnetoresistive film 39 detects a signal magnetic field and converts the detected signal magnetic field into an electrical signal. The structure of the magnetoresistive film 39 is not limited in particular. For example, the magnetoresistive film 39 is formed of a CIP (Current-In-Plane) or CPP (Current-Perpendicular-In-Plane) spin-valve film or a TMR (ferromagnetic tunneling effect) film. Although the reproduction element 38 is unnecessary in the magnetic head 11 according to this embodiment, a description is given herein, taking the composite magnetic head 11 also including the reproduction element 38 as an example.

The recording element 36 includes a lower magnetic pole 36a and an upper magnetic pole 36b each formed of a soft magnetic material such as a FeCo alloy or a NiFe alloy and a recording gap part 37 formed of an alumina film 41 sandwiched between the lower magnetic pole 36a and the upper magnetic pole 36b. The lower magnetic pole 36a and the upper magnetic pole 36b are magnetically connected through a yoke of a soft magnetic material disposed in the depth direction from the medium-opposing surface 34a. Further, a recording coil 43 (FIG. 4) is provided so as to wind around the yoke. A recording current is supplied to the recording coil 43, so that a recording magnetic field leaks out (emanates) from or is absorbed into the lower magnetic pole 36a and the upper magnetic pole 36b. As a result, the recording magnetic field is formed on the measurement medium 50 side of the surface of the recording gap part 37. Besides forming the recording gap part 37, the alumina film 41 is formed to cover a part below the lower shield 40a, the part between the upper shield 40b and the lower magnetic pole 36a, the lower magnetic pole 36a, and the upper magnetic pole 36b.

Referring back to FIG. 1, the reproduction head 60 has the same configuration as the reproduction element 38 of the above-described magnetic head 11. Referring to FIG. 4, the reproduction head 60 includes shield layers 61a and 61b, a magnetoresistive film 62 sandwiched between the shield layers 61a and 61b, and an alumina film 163. Preferably, the width of the magnetoresistive film 62 (the dimension of the magnetoresistive film 62 in the element width directions of the magnetoresistive film 39 shown in FIG. 3) of the reproduction head 60 is less than the width of the recording element 36 of the magnetic head 11. This makes it possible to measure the reproduction output of a magnetic track (a magnetic track 53a shown in FIG. 4) in the element width directions with a higher position resolution in below-described measurement of reproduction output. Accordingly, it is possible to measure the magnetic field strength distribution of the magnetic head 11 in more detail. The reproduction head 60 may be a composite head that further includes a recording element.

The positioning mechanisms 14 and 16 support the magnetic head 11 and the reproduction head 60, respectively. Further, the positioning mechanisms 14 and 16 control the radial positions of the magnetic head 11 and the reproduction head 60 based on instructions from the positioning control parts 13 and 63, respectively.

The positions of the magnetic head 11 and the reproduction head 60 may be controlled by recording tacking servo information on the measurement medium 50 in advance. The tracking servo information reproduced by the magnetic head 11 and the reproduction head 60 is fed to the control operation part 22 through the recording and reproduction control part 19. The control operation part 22 feeds position error correction signals for the heads 11 and 60 to the positioning control parts 13 and 63 based on the tracking servo information. The positioning control parts 13 and 63 control the positions of the magnetic head 11 and the reproduction head 60, respectively, based on the position error correction signals. As a result, the positions of the magnetic head 11 and the reproduction head 60 can be controlled with more accuracy, so that track positioning can be performed with high position accuracy. Consequently, the reproduction output of a magnetic track with better position accuracy is obtained, thus resulting in better position accuracy of the magnetic field strength distribution of the magnetic head 11.

Although not graphically illustrated, the laser light emission part 16 includes a light source such as a semiconductor laser, a condenser lens, a positioning mechanism for determining an exposure position, and a focus servo mechanism. The laser light emission part 16 emits laser light into a spot on the measurement medium 50 based on a laser exposure position control signal and a laser power control signal provided from the emission control part 15.

The emission control part 15 includes an exposure position control part 15a and a laser power control part 15b (FIG. 1). The exposure position control part 15a sets (determines) a laser light exposure position, that is, the position of a laser spot formed on (an underlayer 52 [a recording layer 53] shown in FIG. 4 of) the measurement medium 50. Further, the laser power control part 15b controls laser power within the range of, for example, 0.1 mW to several tens of mW.

As shown in FIG. 1, the laser light emission part 16 is disposed on the opposite side of the measurement medium 50 from the magnetic head 11 (the bottom surface side of the measurement medium 50), and emits laser light from the bottom surface side of the measurement medium 50. This makes it possible to emit laser light onto positions on the recording layer 53 (FIG. 4) of the measurement medium 50 which positions oppose corresponding parts of the medium-opposing surface of the magnetic head 11 as described below.

The recording and reproduction part 19 converts a recording signal of a predetermined recording frequency into a recording current and supplies the recording current to the recording coil 43 (FIG. 4) of the magnetic head 11 based on a command from the control operation part 22, and causes the magnetic head 11 to perform recording on the measurement medium 50. Further, the recording and reproduction part 19 feeds a reproduced signal obtained by the reproduction head 60 to the reproduction output measurement part 21.

The reproduction output measurement part 21 performs A/D conversion on the reproduced signal by detecting its peak values, and feeds the A/D-converted reproduced signal to the control operation part 22 as digital data (reproduction output data).

The control operation part 22 is, for example, a personal computer. The control operation part 22 records the reproduction output data, laser light exposure position information corresponding to the reproduction output data, and head position information in the memory 24. Further, the control operation part 22 performs an operation to convert the reproduction output data into magnetic field strength. Further, the control operation part 22 records the magnetic field strength of the magnetic head 11 in the memory 24 such as a RAM, a hard disk unit, or an optical disk unit, and displays the magnetic field strength of the magnetic head 11 on the display part 25.

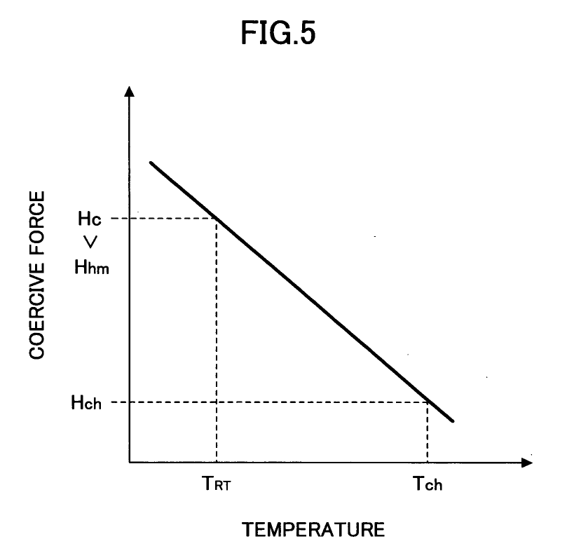

In a below-described second embodiment, the control operation part 22 has the function of converting a temperature Ta at which reproduction output appears into the magnetic field strength of the magnetic head 11 based on the relationship between the coercive force of the measurement medium 50 and temperature (shown in FIG. 5).

Next, a description is given of a method of measuring the magnetic field strength distribution of the magnetic head 11 using the measurement apparatus 10. First, a description is given of measurement principles.

FIG. 4 is a diagram for illustrating a method of measuring the magnetic field strength distribution of a magnetic head according to the first embodiment, showing an enlarged schematic view of the magnetic head 11, which is an object of measurement, the reproduction head 60, and the laser light emission part 16 shown in FIG. 1.

Referring to FIG. 4, the measurement medium 50 is formed by successively stacking the underlayer 52, the recording layer 53, and a protection film 54 on a substrate 51.

A magnetic recording medium having a recording layer whose magnetocrystalline easy axis is oriented along the direction of one of the recording magnetic fields of the magnetic head 11 which one is an object of measurement (for example, a direction parallel to, perpendicular to, or inclined to the substrate surface) is selected as the measurement medium 50.

For example, if the direction of the recording magnetic field to be subjected to measurement is parallel to the substrate surface, a so-called longitudinal (in-plane) magnetic recording medium, or a magnetic recording medium having the recording layer 53 whose magnetocrystalline easy axis is substantially parallel to the substrate surface, is employed. If the direction of the recording magnetic field to be subjected to measurement is perpendicular to the substrate surface, a magnetic recording medium having the recording layer 53 whose magnetocrystalline easy axis is substantially perpendicular to the substrate surface is employed. Further, if the direction of the recording magnetic field to be subjected to measurement is inclined to the substrate surface, a so-called oblique orientation magnetic recording medium, or a magnetic recording medium having the recording layer 53 whose magnetocrystalline easy axis has an angle greater than 0° and less than 90° to the substrate surface, is employed. In the first embodiment, the magnetic field strength of the magnetic head 11 in a direction parallel to the substrate surface (so-called horizontal magnetic field strength) is measured, and a longitudinal magnetic recording medium is employed as the measurement medium 50.

The substrate 51 is not limited in particular as long as the substrate 51 transmits laser light. Preferably, the substrate 51 is a transparent substrate such as a glass substrate or a resin substrate.

Linear unevenness, or so-called texture, may be formed along a recording direction on the surface of the substrate 51. Further, an orientation control film (not graphically illustrated) such as a NiP film may be provided on the surface of the substrate 51. In this case, the texture may be formed along a recording direction on either the surface of the substrate 51 or the surface of the orientation control film. The formation of the texture causes the magnetocrystalline easy axis of the recording layer 53 to be oriented in the recording direction, so that the recording layer 53 having uniaxial anisotropy is formed. As a result, fluctuation in the magnetocrystalline easy axis of the recording layer 53 is reduced, so that it is possible to measure magnetic field strength distribution with higher resolution than in the case of forming no texture. In the case of providing the orientation control film, laser light is emitted onto the orientation control film, and the recording layer 53 is heated by heat conduction through the underlayer 52.

The underlayer 52 is formed of, for example, Cr or a Cr alloy such as CrMo or CrV. As a result, the underlayer 52 is caused to orient the magnetocrystalline easy axis of the recording layer 53 formed of a Co-based alloy parallel to the substrate surface.

A known ferromagnetic material such as a Co-based alloy may be employed for the recording layer 53. Preferably, however, the recording layer 53 is formed of a ferromagnetic material containing Co and Pt, which has large magnetic anisotropy, such as CoPt, CoCrPt, or CoCrPt-M, where M is one selected from the group consisting of B, Mo, Nb, Ta, W, and Cu. As a result, the coercive force can be increased by the addition of Pt to the ferromagnetic material of the recording layer 53, so that a measurement medium having a coercive force higher than the maximum recording magnetic field strength of the magnetic head 11 at room temperature can be obtained easily as described next. Further, even if the crystal grains of the recording layer 53 are fine, for example, 10 nm or less in average grain size, the thermal stability of residual magnetization is good. Accordingly, it is possible to suppress reduction in residual magnetization during measurement.

Further, the recording layer 53 may have two magnetic layers each formed of a ferromagnetic material and a non-magnetic coupling layer of Ru having a thickness of, for example, 0.7 nm between the magnetic layers, where the two magnetic layers are antiferromagnetically coupled to each other. The recording layer 53 having such a structure is more preferable because the thermal stability of residual magnetization is better.

The recording layer 53 may have a so-called granular structure, or a structure formed of multiple crystal grains of a ferromagnetic material and a non-magnetic material (for example, SiO₂) surrounding each crystal grain. It is also preferable in this case that the ferromagnetic material be the one containing Co and Pt as described above in terms of large magnetic anisotropy and good thermal stability. In this case, it is preferable to further form an intermediate layer of Ru or a Ru alloy containing Ru as a principal component between the underlayer 52 and the recording layer 53. This makes it possible to reduce zigzag noise at high recording density, so that it is possible to measure the reproduction output of a finer area, thus increasing the position resolution of reproduction output.

A known material such as a carbon film or hydrogenated carbon may be employed for the protection film 54. Further, although not graphically illustrated, a lubricating layer may be formed on the protection film 54.

Next, a description is given of measurement principles. Referring to FIG. 4 together with FIG. 3, a recording magnetic field (and a leakage magnetic field) is applied to the measurement medium 50 from the magnetic head 11, which is an object of measurement, flying over the surface of the measurement medium 50 at the time of signal recording. The recording magnetic field is generated on the measurement medium 50 side from the lower magnetic pole 36a and the upper magnetic pole 36b near the recording gap part 37 of the magnetic head 11, and is applied to the recording layer 53. A recording magnetic field H₁ (indicated by thick arrows) near the recording gap part 37 has a maximum strength. A relatively weak leakage magnetic field H₂ (indicated by broken arrows) is also generated from other parts of the medium-opposing surface 34a.

Further, at the time of signal recording, laser light emitted from the laser light emission part 16 enters the measurement medium 50 from its bottom side so as to pass (be transmitted) through the substrate 51 and form a laser spot BS in the underlayer 52. The underlayer 52 and the recording layer 53 are heated so that the temperature of a fine area HA smaller in size than the laser spot BS rises to a predetermined value. As a result, the coercive force of the recording layer 53 becomes lower than that at room temperature in the fine area HA, so that the recording layer 53 in the fine area HA is magnetized with a smaller magnetic field strength.

The heated fine area HA is required to be smaller than the size of the recording element 36 in a direction in which measurement is performed. The smaller the heated fine area HA, the better. Hence, the smaller the laser spot BS in size, the better. The spot size (diameter) of the laser spot BS is preferably in the range of, for example, 0.9 μm or less. A spot size about the size of diffraction limit is preferable in particular. The spot size can be particularly small in the case of employing near-field light. The temperature of the fine area HA heated by the laser spot BS is not limited in particular, but should be determined so that no damage is caused to the measurement medium 50.

FIG. 5 is a graph for illustrating measurement principles according to the first embodiment. In FIG. 5, the vertical axis represents the coercive force of the recording layer of a measurement medium, and the horizontal axis represents the temperature of the recording layer.

Referring to FIG. 5 together with FIG. 4, according to the present invention, the coercive force (H_{ch} shown in FIG. 5) of the measurement medium 50 at a temperature (T_{ch} shown in FIG. 5) to which the measurement medium 50 is heated is lower than the coercive force H_{c} of the measurement medium 50 at room temperature T_{RT}. Preferably, the coercive force H_{c} of the measurement medium 50 at room temperature T_{RT} is higher than a maximum recording magnetic field strength Hₕₘ that is generated when a predetermined recording current is supplied to the magnetic head 11.

This is because consequently, recording is performed only in the heated fine area HA and the magnetization layer 53 is not magnetized in the other area even if a recording magnetic field of the maximum recording magnetic field density Hₕₘ is applied to the other area. The coercive force H_{c} of the measurement medium 50 at room temperature T_{RT} may be lower than the maximum recording magnetic field density Hₕₘ. In this case, the coercive force H_{c} at room temperature T_{RT} needs to be such that a reproduced signal from the heated and recorded fine area HA is greater than a reproduced signal from the area other than the fine area HA.

Preferably, the ferromagnetic material of the recording layer 53 of the measurement medium 50 is selected in accordance with the maximum recording magnetic field density Hₕₘ of the magnetic head 11. Further, since the maximum recording magnetic field density Hₕₘ changes in accordance with the magnitude of a recording current caused to flow through the magnetic head 11, the ferromagnetic material of the recording layer 53 is selected in accordance with the change.

Then, by heating the fine area HA of the recording layer 53 (to the temperature T_{ch}) by exposure to laser light, the coercive force of the fine area HA is reduced to H_{ch}. At this point, when a magnetic field greater than the coercive force H_{ch} of the heated fine area HA (the recording magnetic field H₁ or the leakage magnetic field H₂) is applied from the magnetic head 11, the fine area HA is magnetized. In the magnetized fine area HA, magnetization M (indicated by outline arrow M) remains even when the temperature is lowered to room temperature, and the magnetic track 53a is formed in the recording layer 53. The magnetic track 53a is substantially equal in width to the fine area HA, and is formed along a moving direction RD in which the measurement medium 50 moves. The magnetization M of the magnetic track 53a formed herein has a magnetization corresponding to the magnetic field strength applied in the heated state.

It is preferable that the coercive force H_{ch} of the heated recording layer 53 be as low as possible, for example, 2 kOe or less. This makes it possible to detect every leakage magnetic field.

The coercive force of the recording layer 53 having the magnetic track 53a formed therein returns to H_{c} when the temperature returns to room temperature. Accordingly, even if the recording magnetic field H₁ (the maximum recording magnetic field density Hₕₘ) is applied near the magnetic gap part 37 in this state, the magnetization M of the magnetic track 53a is not affected thereby and remains. That is, even if a laser light exposure position is set on the upstream side in the moving direction RD of the measurement medium 50, the magnetization M of the magnetic track 53a is not affected by the recording magnetic field H₁ of the magnetic gap part 37. Accordingly, the magnetic track 53a corresponding to the strength of a leakage magnetic field (or a recording magnetic field) is formed at any position on the recording layer 53 corresponding to the medium-opposing surface 34a. Therefore, it is possible to measure magnetic field strength at any position on the recording layer 53 corresponding to the medium-opposing surface 34a. It is also possible to reduce a magnetic field from the recording gap part 37 onto a measurement position by providing the magnetic head 11 with a skew angle. In this case, it is possible to perform measurement even if the coercive force H_{c} at room temperature T_{RT} is smaller than the maximum recording magnetic field density Hₕₘ.

At the time of reproducing (reading) the magnetic track 53a, the emission of laser light is stopped (OFF), and the magnetic track 53a of the recording layer 53 is read with the reproduction head 60. Then, reproduction output, for example, the peak value of a reproduced signal waveform, is measured. As a result, reproduction output corresponding to the magnitude of the magnetization M is obtained. As is described below, this reproduction output is converted into magnetic field strength, so that the magnetic field strength distribution of the magnetic head 11 is finally obtained.

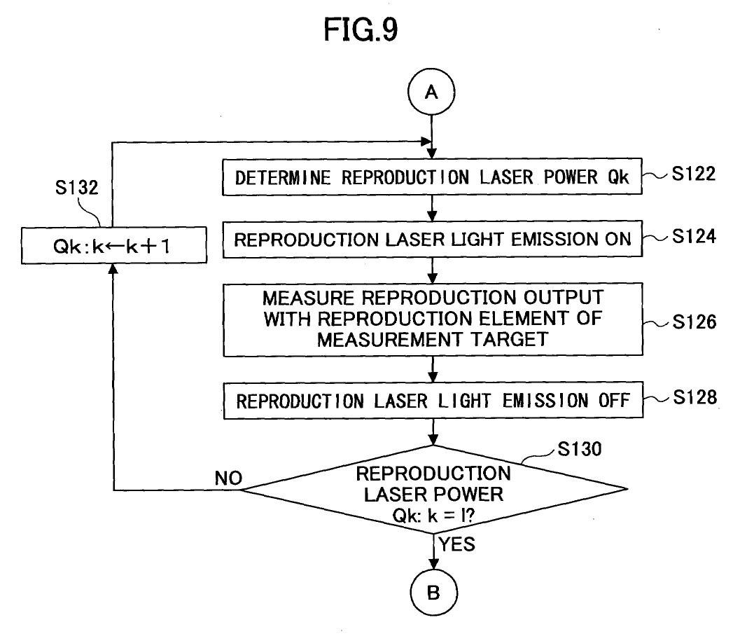

FIG. 6 is a flowchart showing a method of measuring the magnetic field strength distribution of a magnetic head according to the first embodiment. Branching to FIG. 9 and step S134 in FIG. 6 are not included in this measurement method, and are performed in a below-described method of measuring the position of the magnetic sensing part of a reproduction element.

A description is given, with reference to FIG. 6 together with FIGS. 1 and 4, of a method of measuring the magnetic field strength distribution of a magnetic head according to this embodiment.

First, in step S102, initial settings are provided. In the initial settings, the measurement medium 50 (already demagnetized) is attached to the measurement apparatus 10. The measurement medium 50 is rotated at predetermined rpm so as to cause the magnetic head 11 to be subjected to magnetic field strength distribution measurement to fly over the measurement medium 50, and positioning of the magnetic head 11 is performed. Further, a predetermined recording current to be supplied to the magnetic head 11 is determined. A desired recording current value and recording frequency are selected for the recording current. Further, the reproduction head 60 is caused to fly over the measurement medium 50, and the reproduction head 60 is positioned at a radial position at which the magnetic field strength distribution of the magnetic head 11 is obtained. Further, the laser light emission part 16 is positioned so that laser light is emitted onto a reference position, for example, the position of the magnetic gap part 37. The magnetic head 11 may erase data in the recording layer 53 of the measurement medium 50 at this point.

The skew angle of each of the magnetic head 11 and the reproduction head 60 is set at, for example, 0°. The skew angle refers to an angle that the recording element longitudinal directions of the recording element 36 of the magnetic head 11 form with the moving direction (recording direction) of the measurement medium 50 in a virtual plane parallel to the substrate surface of the measurement medium 50.

It is not always required to cause the magnetic head 11 to fly over the measurement medium 50. The magnetic head 11 may also be fixed above the measurement medium 50 at such a distance from the measurement medium 50 as to enable recording. As a result, the magnetic head 11 avoids heat conduction from the heated recording layer 53, so that the recording and reproduction characteristics of the recording element 36 and the reproduction element 38 are stabilized.

Further, the magnetic field strength distribution is obtained at a laser light exposure position Li (i=1 to n). The laser light exposure position Li is suitably selected in accordance with the purpose of measurement. For example, the laser light exposure position Li is selected along an X₁ axis shown in FIG. 3. The X₁ axis passes through the center of the magnetic gap part 37 and is parallel to the X-axis.

Next, in step S104, the laser light exposure position Li (i=1) is set (determined). The laser light exposure position Li (i=1) is determined by the exposure position control part 15a.

Next, in step S106, laser light is emitted with predetermined laser power, and in step S108, the preset recording current is supplied to the recording element 36 of the magnetic head 11, thereby performing signal recording. As a result, a recording magnetic field (leakage magnetic field) from the magnetic head 11 is applied to the laser light exposure position Li, that is, the heated fine area HA, so that the recording layer 53 is magnetized. As a result, the magnetic track 53a is formed in the recording layer 53.

Next, in step S110, the emission of laser light is stopped. In step S112, the reproduction output of the magnetic track 53a is measured with the reproduction head 60 after at least one rotation after the signal recording. Specifically, the reproduction head 60 is positioned at the radial position of the magnetic track 53a, and a signal magnetic field from the magnetic track 53a is detected. A reproduced signal obtained thereby is amplified in the recording and reproduction control part 19, and the average of the amplitude of the reproduced signal (reproduction output) is obtained by the reproduction output measurement part 21. The laser light exposure position Li and the corresponding reproduced signal are correlated as a pair of data. The amplitude values of the reproduced signal, or a so-called track profile, may be measured while changing the radial position of the reproduction head 60 little by little around the radial position of the magnetic track 53a, and its maximum value may be employed as reproduction output.

Next, in step S114, it is determined whether measurement has been performed at all of the desired laser light exposure positions Li. If measurement has not been performed at all of the desired laser light exposure positions Li (NO in step S114), in step S116, the laser light exposure position Li is replaced by the next laser light exposure position Li, and in step S117, the magnetic track 53a is erased. The magnetic track 53a is erased by AC erasure or DC erasure by the magnetic head 11. At this point, laser light may be emitted onto the magnetic track 53a (recording layer 53) so as to increase the temperature of the recording layer 53, and the magnetic track 53a may be erased with a lower magnetic field by the magnetic head 11.

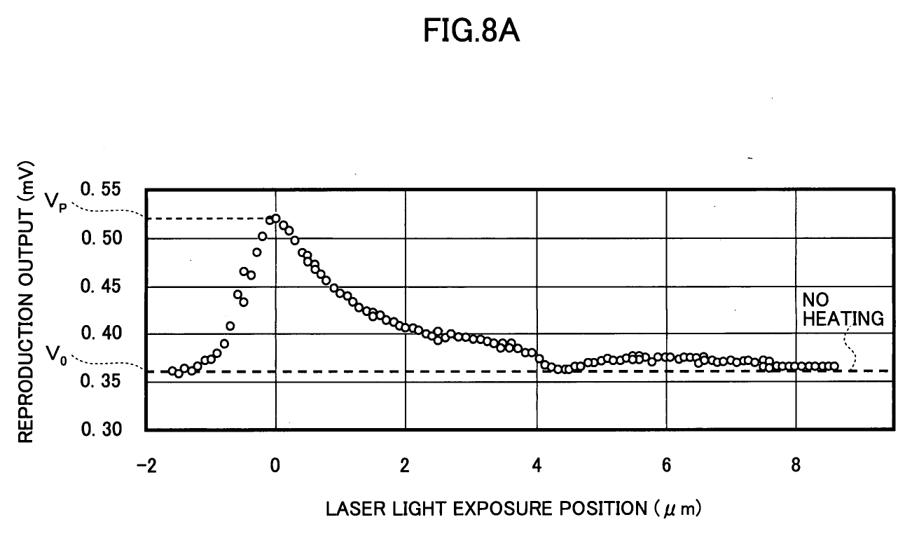

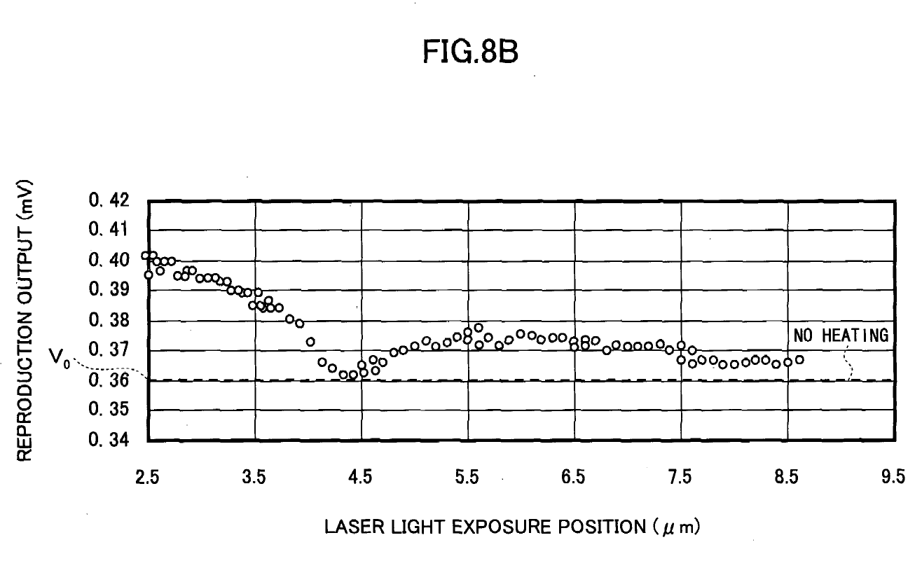

Next, steps S104 through 112 are performed. If measurement has been performed at all of the laser light exposure positions Li (YES in step S114), in step S118, the reproduction output (individual reproduction outputs) is converted into magnetic field strength based on the obtained relationship between the laser light exposure positions Li and the corresponding reproduction outputs. In this step (S118), first, each laser light exposure position Li is replaced by a corresponding position on the medium-opposing surface of the magnetic head 11, the position opposing the laser light exposure position Li. As a result, the relationship between the positions on the medium-opposing surface and the reproduction outputs is determined. This relationship is the profile of the reproduction outputs corresponding to the medium-opposing surface, which is, for example, as shown in below-described FIGS. 8A and 8B.

Further, in this step (S118), the reproduction output is converted into magnetic field strength in the relationship between the positions on the medium-opposing surface and the individual reproduction outputs. The recording magnetic field strength of at least one of the laser light exposure positions Li (where the reproduction output has been measured) is separately measured. This measurement is performed by, for example, a measurement method according to the second embodiment or, if applicable, the method of Patent Document 1 using an electron beam as described above as related art. Assuming that the recording magnetic field strength is proportional to the reproduction output, the reproduction output is converted into magnetic field strength based on the relationship between the separately measured recording magnetic field strength and the reproduction output of the position thereof. For example, a position on the recording layer 53 corresponding to the magnetic gap part 37 is included in the laser light exposure positions Li. Then, assuming that the recording magnetic field strength is proportional to the reproduction output, the reproduction output is converted into magnetic field strength based on the ratio of the separately measured maximum recording magnetic field strength Hₕₘ at the magnetic gap part 37 to the peak value VP (a value after subtracting noise level) of the reproduction output obtained at the magnetic gap part 37 (=Hₕₘ/Vₚ). As a result, the recording magnetic field strength distribution of the magnetic head 11 at the positions on the recording layer 53 is obtained.

According to this measurement method, the measurement medium 50, which, at room temperature, has a coercive force higher than the maximum recording magnetic field strength Hₕₘ of the measurement-target magnetic head 11 at a predetermined recording current, is employed. Then, by heating the recording layer 53 by emitting laser light of a fine laser spot onto the measurement medium 50, the coercive force of the recording layer 53 becomes lower in the heated fine area HA than in the other area. Therefore, only the fine area HA is magnetized by a recording magnetic field (including a leakage magnetic field) from the magnetic head 11, so that a magnetic track is formed. The reproduction output is measured from the magnetic track by the reproduction head 60, and the reproduction output is converted into magnetic field strength. Thereby, it is possible to detect the magnetic field strength of the recording magnetic field. Further, by changing the laser light exposure position Li and measuring reproduction outputs corresponding to multiple laser light exposure positions, the recording magnetic field strength distribution of the magnetic head 11 can be obtained. Accordingly, the magnetic field strength distribution can be measured with a simple method.

Further, according to this measurement method, measurement is performed at different laser light exposure positions while having the magnetic head 11 fixed. Accordingly, it is possible to prevent error caused by movement of the magnetic head 11, such as position error (deviation).

According to this measurement method, the reproduction output is measured by the reproduction head 60. Alternatively, the reproduction output may be measured using the reproduction element 38 of the magnetic head 11. In this case, depending on the measurement position (that is, the laser light exposure position), it may be necessary to move the magnetic head 11 in order to measure reproduction output, but it is possible to avoid the trouble of using the reproduction head 60.

In the above-described method of measuring magnetic field strength distribution, even a process only up to the stage of obtaining the reproduction output distribution corresponding to the medium-opposing surface, that is, a process only up to the stage before conversion into magnetic strength, is included in the first embodiment of the present invention. This is because effective information on the recording magnetic field strength distribution of the magnetic head 11 can be obtained from the shape of the reproduction output profile corresponding to the medium-opposing surface. That is, for example, by comparing a magnetic field strength distribution obtained with a simulation based on the design of the magnetic head 11 with the shape of the reproduction output profile corresponding to the medium-opposing surface, it is possible to discover abnormal magnetic field leakage (sub peak), etc., that is not intended in the design of the magnetic head 11.

Further, in the above-described method of measuring magnetic field strength distribution, the skew angle of the magnetic head 11 is 0°. However, the skew angle of the magnetic head 11 is not limited to 0°, and may be ±10° or an angle greater than ±10° in absolute value.

Next, a description is given of the case where the magnetic field strength distribution of the magnetic head 11 having the structure shown in FIG. 3 was measured as an example implementation of the first embodiment.

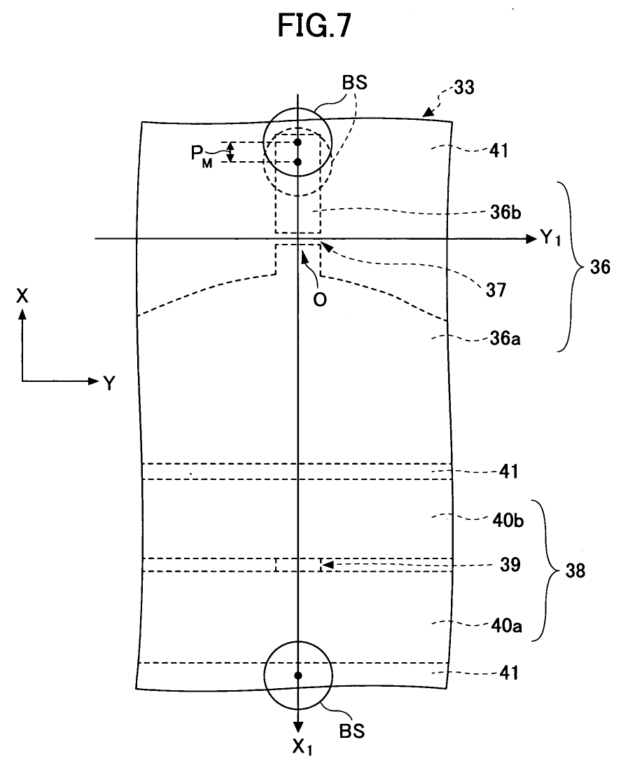

FIG. 7 is a diagram for illustrating a laser light exposure position according to the example implementation.

Referring to FIG. 7, in this example implementation, the recording magnetic field strength distribution of a magnetic head was measured using a longitudinal recording magnetic head and a longitudinal recording medium in which the magnetocrystalline easy axis of a recording layer is oriented in plane as a measurement medium. The magnetic head has the same configuration as that of FIG. 3, and an upper magnetic pole has a width (dimension measured in the element width directions) of 0.25 μm. Further, the measurement medium has a Cr-based alloy underlayer on a glass substrate, and has a coercive force of 5.3 kOe at room temperature. A change in the coercive force of the measurement medium relative to temperature at the time of heating with below-described laser light is approximately 25 Oe/degree.

Further, a laser head of a 655 nm wavelength was employed as a laser light emission part. Laser light emitted from the laser head was caused to enter the measurement medium from its glass substrate side, so that a laser spot BS of 0.9 μm in diameter was formed. The laser spot BS was formed at positions (laser light exposure positions) along the X₁ axis from a position of −2 μm on the upper magnetic pole 36b side to a position of approximately 8.5 μm on the reproduction element 38 side with the center of the magnetic gap part 37 serving as an origin. Further, a measurement pitch (the pitch of the laser light exposure positions) P_{M} of 0.1 μm was employed. The X₁ axis is parallel to the recording element longitudinal directions (X-axial directions), and passes through the center in the element width directions (the center O of the recording gap part 37).

The measurement method according to the example implementation is the same as the measurement method shown in the flowchart of FIG. 6. A recording current of 50 mA and a recording frequency of 176 kFCI were employed. This recording current is substantially the same as a recording current to be caused to flow through the above-described magnetic head at the time of erasing data from a magnetic disk having a coercive force of approximately 4.5 kOe.

FIG. 8A is a graph showing reproduction output at the laser light exposure position of the example implementation. FIG. 8B is a graph showing the reproduction output of FIG. 8A around a reproduction element. In FIGS. 8A and BB, the vertical axis represents reproduction output, which is the average output of tracks formed to make an approximately one round in the measurement medium. Further, the horizontal axis represents a distance from the center O of the magnetic gap part 37 shown in FIG. 7 along the X₁ axis. The distance on the negative (minus) side indicates the upper magnetic pole 36b side of the recording element 36, and the distance on the positive (plus) side indicates the reproduction element 38 side. Further, the reproduction output in the case of not emitting laser light is indicated by a broken line for comparison.

Referring to FIGS. 8A and BB, in the case of not emitting laser light, obtained is a reproduction output of V₀=0.36 mV, which corresponds to a noise level, and corresponds to a signal level recorded at the recording gap part 37 in the case of a measurement medium whose coercive force H_{c} at room temperature is smaller than the maximum recording magnetic field strength Hₕₘ. A signal recorded in a heated area is recorded with a level higher than this level, so that a reproduction output greater than V₀ is obtained. On the other hand, in the case of emitting laser light, the reproduction output is greater than 0.36 mV, and maximizes at the recording gap part 37 (around where the distance is zero). Further, FIGS. 8A and BB show that the reproduction output is obtained in the area other than the recording gap part 37 and that the reproduction output gradually decreases toward the reproduction element 38 (at a distance of approximately 3 μm or more) from the recording gap part 37 so as to be substantially equal to that in the case of not emitting laser light at the magnetoresistive film 39 serving as a magnetic sensing part (around where the distance is approximately 4.4 μm). The reproduction element 38 has such a structure that a leakage magnetic field does not affect the magnetoresistive film 39 even at the time of recording (when a recording magnetic field is being generated), which coincides with the fact that the reproduction output is a noise level.

Further, it is also shown that the reproduction output having a sufficient position resolution is obtained with the laser spot BS of 0.9 μm in diameter and the measurement pitch P_{M} of 0.1 μm.

Further, it is possible to obtain the magnetic field strength distribution of the magnetic head 11 by converting the reproduction output into magnetic field strength based on the ratio of the separately measured maximum recording magnetic field strength Hₕₘ at the magnetic gap part 37 to the difference (0.16 mV) between the maximum value VP (0.52 mV) of the reproduction output at the recording gap part 37 (around where the distance is zero) and the noise level (0.36 mV).

Further, the position of the magnetic sensing part of a reproduction element may be additionally measured in the method of measuring the magnetic field strength distribution of a magnetic head according to the first embodiment. In this measurement, the measurement apparatus 10 shown in FIG. 1 continues to be used. The laser light exposure position Li is set at positions on the X₁ axis as in the above-described example implementation so as to further include the magnetic sensing part of the reproduction element 38.

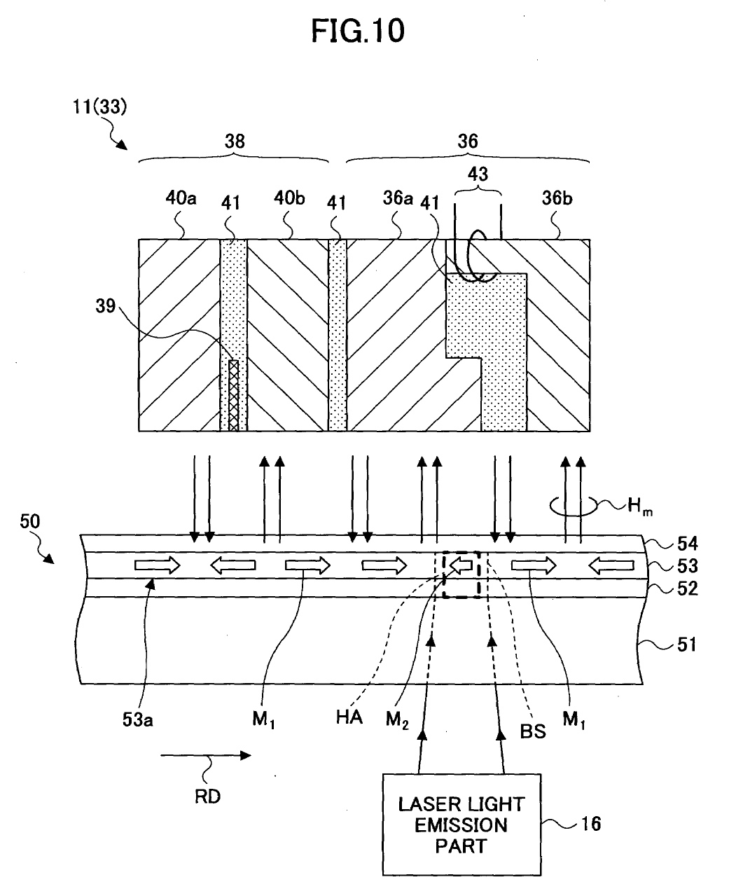

FIG. 9 is a flowchart showing a method of measuring the position of the magnetic sensing part of a reproduction element. FIG. 10 is a diagram for illustrating principles of measuring the position of the magnetic sensing part of the reproduction element. In FIGS. 9 and 10, the parts corresponding to those described above are referred to by the same reference numerals, and a description thereof is omitted.

Referring to FIGS. 9 and 10 together with FIG. 6, after measurement of the reproduction output (step S112) in the measurement method shown in FIG. 6, each step shown in the flowchart of FIG. 9 is performed while keeping the laser light exposure position Li as it is. In step S122, the levels of the laser power for reproduction (reproduction laser power) Qk (k=1 to l) of the magnetic head 11 are arranged (determined) so that the laser power Qk gradually increases from Q1 to Ql.

Next, in step S124, laser light of the reproduction laser power Qk (k=1) is emitted onto the laser light exposure position Li by the laser light emission part 16. Next, in step S126, the reproduction output of the track (formed in step S108 of FIG. 6) is measured by the reproduction element 38 of the magnetic head 11.

Next, in step S128, the emission of laser light is stopped (OFF). In step S130, it is determined whether measurement has been performed with respect to all the desired levels of the reproduction laser power Qk. If measurement has not been performed with respect to all the desired levels of the reproduction laser power Qk (NO in step S130), in step S132, the laser power Qk is replaced by the next laser power Qk, and steps S122 through S132 are performed.

If measurement has been performed with respect to all the desired levels of the reproduction laser power Qk (k=1, YES in step S130), the operation proceeds to step S114 of FIG. 6. By steps S122 through S132 described above, the relationship between the reproduction laser power Qk and the reproduction output at one laser light exposure position Li is obtained.

Next, as shown in the flowchart of FIG. 6, in step S134, the position of the magnetic sensing part of the reproduction element 38 is detected after conversion into magnetic field strength (step S118). At this point, the relationship between the reproduction laser power Qk and the reproduction output has been obtained with respect to each laser light exposure position Li (i=1 to n). Regarding each reproduction laser power Qk (level), the reproduction output is plotted with respect to the laser light exposure position Li. The position where the obtained curve indicates a minimum value is the position of the magnetic sensing part (magnetoresistive film 39) of the reproduction element 38.

It is inferred that these principles of measurement are as follows. Referring to FIG. 10, the magnetization (residual magnetization) M₁ of the magnetic track 53a formed in the recording layer 53 of the measurement medium 50 is reduced in amount to magnetization M₂ in the heated fine area HA when the recording layer 53 is sufficiently heated by laser light of the reproduction laser power Qk. Accordingly, the strength of a magnetic field Hm leaking out (emanating) from the magnetization M2 is reduced. When the measurement medium 50 moves so that the area of the recording layer 53 having the magnetization M₂ is out of the fine area HA, the temperature of the recording layer 53 is lowered, so that the magnetization M₂ returns to the magnetization M₁ of the original amount of magnetization. Since this change in magnetization (amount) is fast, the magnetization M₁ is detected when an area out of the area opposing the magnetoresistive film 39 in the recording layer 53, for example, an area of the recording layer 53 on the downstream side (on the right side in the plane of the paper) of the magnetoresistive film 39 in the moving direction RD of the measurement medium 50, is heated by the laser light emission part 16. Further, when an area of the recording layer 53 on the upstream side (on the left side in the plane of the paper) of the magnetoresistive film 39 in the moving direction RD of the measurement medium 50 is heated, the magnetization temporarily changes to M₂. However, at the position of the magnetoresistive film 39, the temperature decreases so that the reproduction output is obtained where the magnetization has returned from M₂ to M₁. On the other hand, when an area of the recording layer 53 near the position opposing the magnetoresistive film 39 is heated, the reproduction output corresponding to the magnetization M₂ is detected by the magnetoresistive film 39, so that the reproduction output is reduced. Accordingly, it is determined that the magnetoresistive film 39 is positioned at a laser light exposure position Li where the reproduction output shows a minimum value.

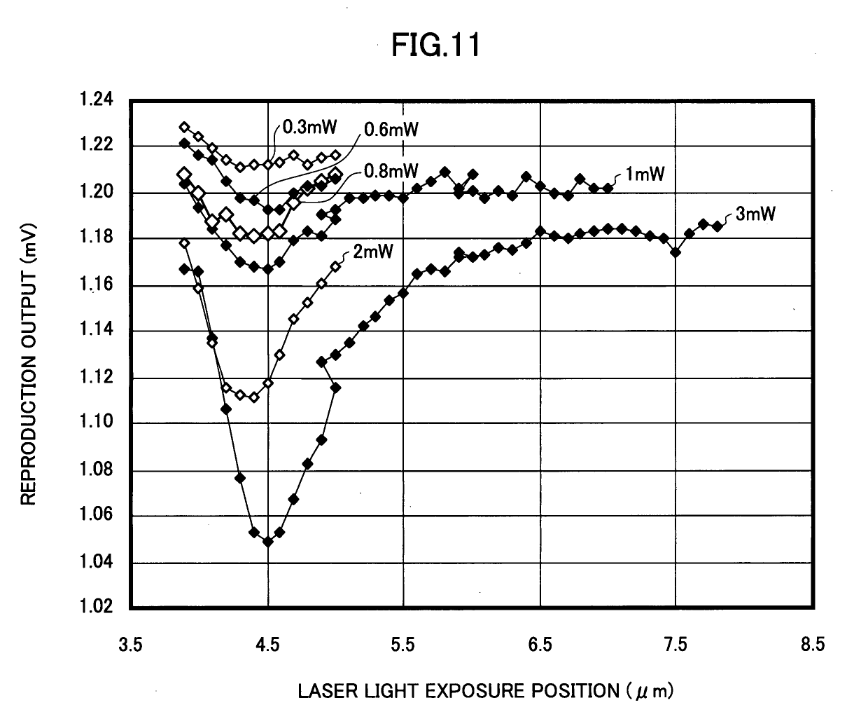

FIG. 11 is a graph showing a case of measuring the position of the magnetic sensing part of a reproduction element, where measurement was performed at intervals of 0.1 μm along the X₁ axis shown in FIG. 7 in an area near the magnetic sensing part (magnetoresistive film) of the reproduction element using the same configuration as in the above-described example implementation. The vertical axis represents the reproduction output of the above-described tracks, which is the average of outputs measured for approximately one round of the measurement medium. Further, the horizontal axis represents a distance from the center O of the magnetic gap part 37 shown in FIG. 7 along the X₁ axis. The distance on the negative (minus) side indicates the upper magnetic pole 36b side of the recording element 36, and the distance on the positive (plus) side indicates the reproduction element 38 side. Here, the levels of the reproduction laser power Qk were set (determined) as 0.3, 0.6, 0.8, 1.2, and 3 mW in this order.

Referring to FIG. 11 together with FIG. 10, when the reproduction laser power Qk is low, a substantially flat reproduction output is obtained with respect to the laser light exposure position Li. As the reproduction laser power Qk increases, the reproduction output shows a minimum value at 4.5 μm. The magnetoresistive film 39 is positioned opposite the laser light exposure position Li in the recording layer 53 where the reproduction output shows this minimum value, and the distance from the center O of the magnetic gap part 37 shown in FIG. 7 to the magnetoresistive film 39 can be determined. FIG. 11 shows that the magnetoresistive film 39 is formed at a position of +4.5 μm from the center O of the magnetic gap part 37 shown in FIG. 7. The position of the magnetoresistive film 39 thus determined substantially coincided with its design position.

This measurement of the position of the magnetic sensing part (magnetoresistive film 39) of the reproduction element 38 can be magnetically performed, and moreover is simple. The method of measuring the position of the magnetic sensing part (magnetoresistive film 39) of the reproduction element 38 can also be applied in the below-described case where the magnetic head is a perpendicular recording magnetic head.

The measurement of the position of the magnetic sensing part of the reproduction element shown in FIG. 9 may be performed after YES in step S114 instead of after step S112 shown in FIG. 6. In this case, a signal is prerecorded in an area of the recording layer opposing the magnetic sensing part (magnetoresistive film). Then, the measurement of the position of the magnetic sensing part of the reproduction element shown in FIG. 9 is performed, and position measurement by recording and reproduction is repeatedly performed while changing the laser light exposure position. Finally, detection of the position of the magnetic sensing part of the reproduction element of step S134 shown in FIG. 6 is performed.

Next, a description is given of the measurement method in the case where the magnetic head is a perpendicular recording magnetic head in the above-described method of measuring the magnetic field strength distribution of a magnetic head according to the first embodiment.

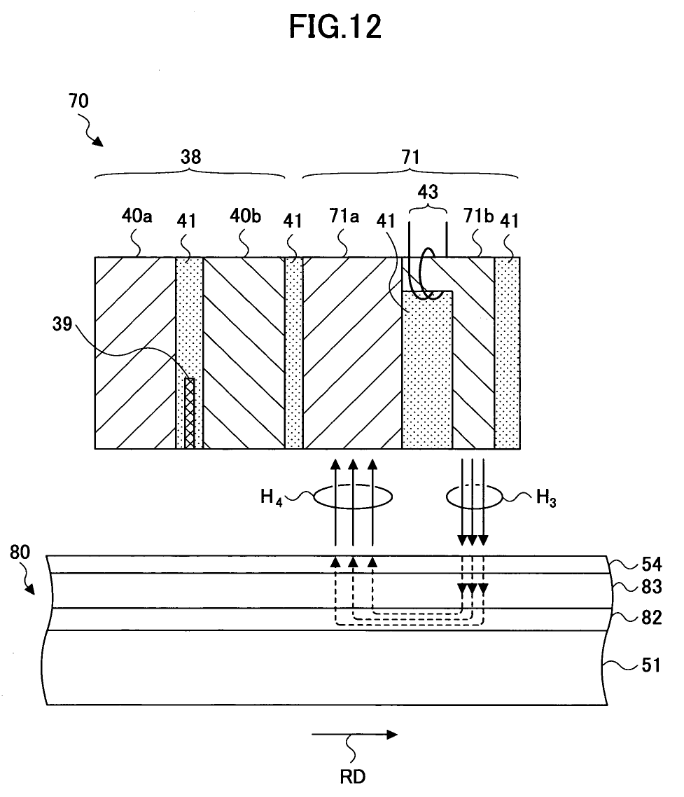

FIG. 12 is a diagram for illustrating a recording magnetic field of a perpendicular recording magnetic head. In FIG. 12, the parts corresponding to those described above are referred to by the same reference numerals, and a description thereof is omitted.

Referring to FIG. 12, a magnetic head 70 for perpendicular recording has an element part formed of a recording element 71 and the reproduction element 38. The reproduction element 38 has the same configuration as the reproduction element 38 shown in FIGS. 3 and 4. Further, the recording element 71 includes a main magnetic pole 71b, an auxiliary magnetic pole 71a, and the recording coil 43. The main magnetic pole 71b applies a recording magnetic field to a perpendicular magnetic recording medium (measurement medium) 80 from the medium-opposing surface. The auxiliary magnetic pole 71a causes the recording magnetic field to flow back.

The measurement medium 80 is formed by stacking a soft magnetic underlayer 82, a recording layer 83, the protection film 54, etc., on the substrate 51. The soft magnetic underlayer 82 is formed of a soft magnetic material, and has a magnetocrystalline easy axis in its plane. Accordingly, magnetic flux of the recording magnetic field passes in an in-plane direction.

At the time of measuring magnetic field strength distribution, laser light is emitted onto the soft magnetic underlayer 82, so that the soft magnetic underlayer 82 is heated. It is preferable that a change in the saturation magnetization of the soft magnetic underlayer 82 be smaller within the range of a change in temperature due to heating. Further, it is preferable that the change in the saturation magnetization be substantially constant (within 3% with reference to saturation magnetization at 20° C.). This makes it possible to suppress or avoid the influence of a change in the soft magnetic underlayer 82 over a change in reproduction output, so that it is possible to measure magnetic field strength with high accuracy.

Further, it is preferable that a change in the coercive force of the soft magnetic underlayer 82 be smaller within the range of a change in temperature due to heating. Further, it is preferable that the change in the coercive force be substantially constant (within 10% with reference to a coercive force at 20° C.). This makes it possible to measure the state of a magnetic field at the time of recording with more accuracy including the effect of the soft magnetic underlayer 82.

Further, the recording layer 83 is formed of, for example, CoCrPt or a CoCrPt-based alloy, and has its magnetocrystalline easy axis oriented in a direction perpendicular to the film surface. Accordingly, it is possible to measure the magnetic field strength distribution of the magnetic head 70 in the direction perpendicular to the film surface.

A recording current is supplied to the recording coil 43, so that the recording element 71 generates a recording magnetic field from the medium-opposing surface of the main magnetic pole 71b to the measurement medium 80 side. The recording magnetic field is applied to the recording layer 83 in a direction perpendicular to its film surface, and flows back to the auxiliary magnetic pole 71a through the soft magnetic underlayer 82. Accordingly, the soft magnetic underlayer 82 together with the main magnetic pole 71b substantially functions as a magnetic pole of the recording element 71. That is, the magnetic field strength distribution of the recording element 71 is formed through interaction with the measurement medium 80. Accordingly, in order to measure the recording magnetic field distribution of the perpendicular recording magnetic head 70, it is necessary to dispose the magnetic head 70 with the same configuration as at the time of actual recording and reproduction. This makes it difficult to measure the recording magnetic field strength and its distribution of a perpendicular recording magnetic head with good accuracy with the conventional method using an electron beam. On the other hand, according to this embodiment of the present invention, the magnetic field strength distribution of the magnetic head 70 is measured with the magnetic head 70 and the measurement medium 80 being disposed with the same configuration as at the time of actual recording and reproduction. Therefore, it is possible to measure the magnetic field strength distribution at the time of recording.

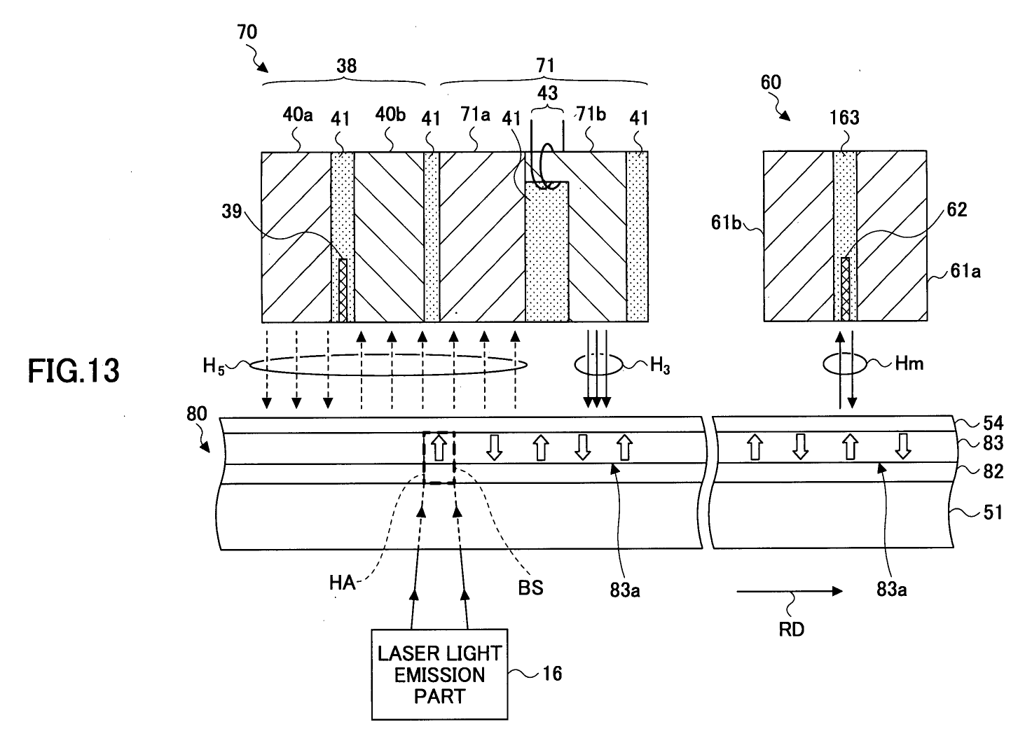

FIG. 13 is a diagram for illustrating a method of measuring the magnetic field strength distribution of a perpendicular recording magnetic head according to this embodiment. In FIG. 13, the parts corresponding to those described above are referred to by the same reference numerals, and a description thereof is omitted.

Referring to FIG. 13, at the time of signal recording, a recording magnetic field H₃ (indicated by thick arrows) and a leakage magnetic field H₅ (indicated by broken arrows) are applied to the measurement medium 80 from the measurement-target perpendicular recording magnetic head 70 flying over the surface of the measurement medium 80. The recording magnetic field H₃ is generated on the measurement medium 80 side from the main magnetic pole 71b of the recording element 71 so as to be applied to the recording layer 83. The recording magnetic field H₃ near the main magnetic pole 71b is the largest, but the recording magnetic field H₅, which is relatively weak, leaks out (emanates) from the other part of the medium-opposing surface.

The operation of the laser light emission part 16 and the action of the measurement medium 80 exposed to laser light at the time of signal recording is the same in the case of FIG. 4, and accordingly, a detailed description thereof is omitted. The recording layer 83 is heated through the soft magnetic underlayer 82 exposed to laser light, so that its temperature increases. Therefore, the recording layer 83 has a lower coercive force than at room temperature so as to be magnetized with lower magnetic field strength so that a magnetic track is formed. The method of measuring the magnetic field strength distribution of the perpendicular recording magnetic head 70 is the same as that shown in the flowchart of FIG. 6, and accordingly, a description thereof is omitted.

According to this measurement method, it is possible to determine the magnetic field strength distribution of a perpendicular recording magnetic head at the time of recording, and that with good accuracy.

### Second Embodiment

A method of measuring the magnetic field strength distribution of a magnetic head according to the second embodiment of the present invention is a variation of the method of measuring the magnetic field strength distribution of a magnetic head according to the first embodiment, and is the same as that of the first embodiment except for performing conversion into magnetic field strength with a different technique. Further, the same measurement apparatus, magnetic head, and principles of measurement as shown in FIG. 1, FIGS. 2 and 3, and FIGS. 4 and 5, respectively, are employed in this embodiment. Accordingly, a description is given, with reference to FIGS. 1 through 5, of a measurement method according to this embodiment.

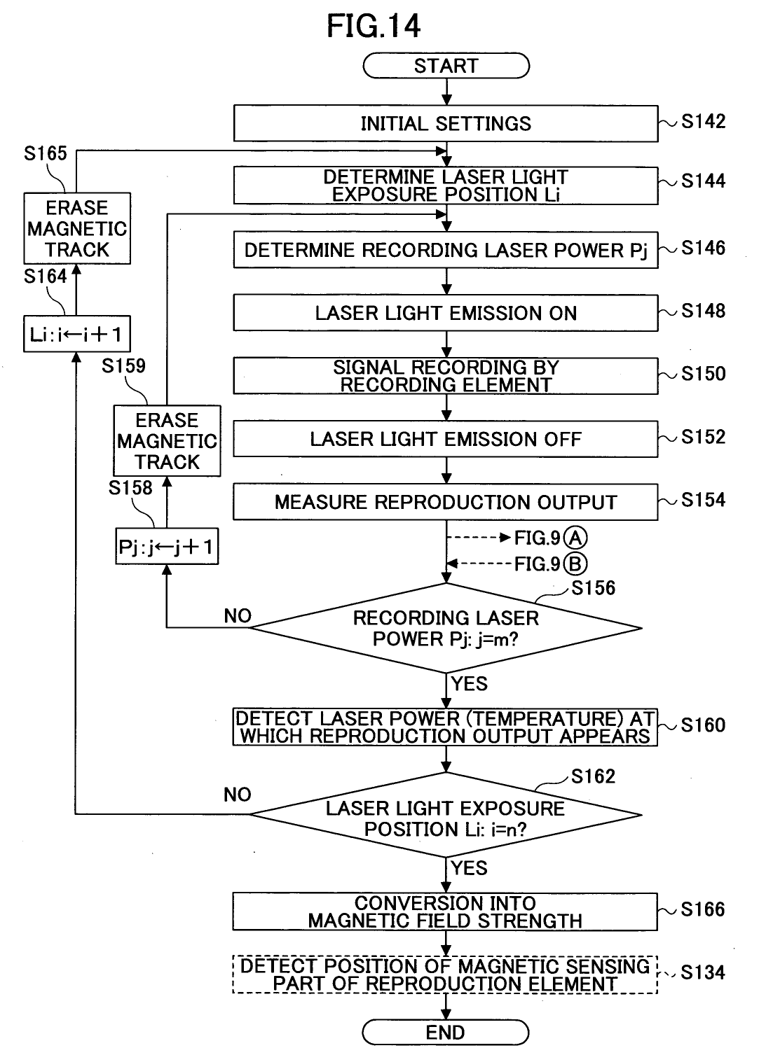

FIG. 14 is a flowchart showing a method of measuring the magnetic field strength distribution of a magnetic head according to the second embodiment of the present invention.

Referring to FIG. 14, this measurement method is substantially the same as the measurement method shown in FIG. 6 except for measuring reproduction output with different levels of laser power for recording (recording laser power) Pj. Specifically, after initial settings are provided in step S142, the laser light exposure position Li is determined in step S144, the recording laser power Pj is set (determined) in step S146, laser light is emitted in step S148, signal recording is performed with a recording element in step S150, the emission of laser light is stopped in step S152, and reproduction output is measured in step S154. Of these steps, steps S142, S144, and S148 through S154 are performed in the same manner as steps S102 through S112, respectively, shown in FIG. 6. The levels of the recording laser power Pj (j=1 to m) are arranged (determined) so that the recording laser power Pj gradually increases from P1 to Pm.

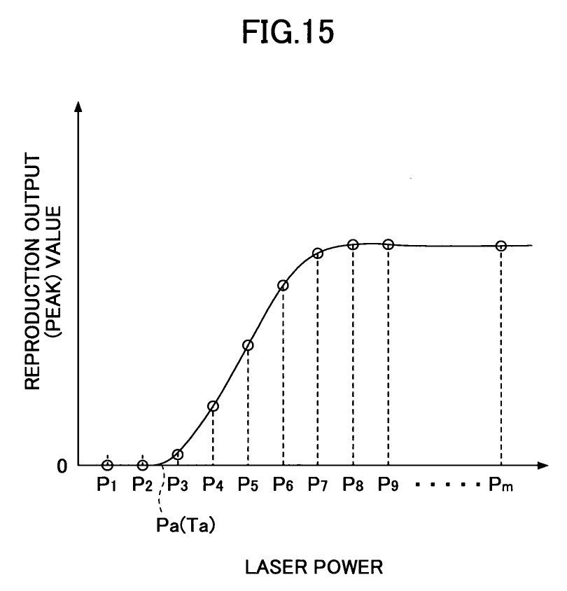

FIG. 15 is a graph showing the relationship between reproduction output and laser power. In FIG. 15, the vertical axis represents the reproduction output obtained in step S154 of FIG. 14, and the horizontal axis represents the recording laser power Pj.

Referring to FIG. 15 together with FIG. 14, as the recording laser power Pj increases, the reproduction output of the magnetic track formed in the recording layer by a magnetic field leaking out (emanating) from the magnetic head at the time of signal recording increases from zero or an initial value. In FIG. 14, the recording laser power Pj is set to P1 through Pm in step S158 and step S146, the magnetic track is erased in step S159, and the reproduction output is measured after recording a magnetic track in steps S148 through S154. By repeating this operation, the relationship of FIG. 15 is obtained with respect to one laser light exposure position Li.

When measurement of reproduction output is completed with respect to all the levels of the recording laser power Pj (YES in step S156), in step S160, a laser power (level) Pa at which the reproduction output starts to appear is detected based on the relationship of FIG. 15. In this detection, the laser power (level) Pa at which the reproduction output starts to appear is determined based on the relationship of FIG. 15. The laser power Pa is determined by, for example, determining the laser power at which the reproduction output becomes zero using the least squares method. The method of determining the laser power Pa at which the reproduction output appears is not limited to this.

Preferably, the initial recording laser power P1 is set to a level at which at least the recording layer is not magnetized. This makes it possible to determine, with good accuracy, the laser power Pa at which the reproduction output starts to appear.

Further, in this step S160, a temperature Ta corresponding to the laser power Pa, at which temperature Ta the reproduction output starts to appear, is determined based on the relationship between the recording laser power Pj and the temperature of the recording layer heated by the recording laser power Pj. As a result, the temperature Ta at which the reproduction output starts to appear at the laser light exposure position Li is obtained.

Next, in steps S144 through S165, the temperature Ta is determined in the same manner with respect to the laser light exposure position Li (i=2 to n).

Next, in step S166, the temperature Ta at which the reproduction output starts to appear at each laser light exposure position Li is converted into magnetic field strength. This conversion is performed based on the relationship between the coercive force of the measurement medium and temperature shown in FIG. 5. That is, a coercive force corresponding to the temperature Ta at which the reproduction output starts to appear is obtained based on the relationship of FIG. 5. Then, the obtained coercive force is determined as magnetic field strength. As a result, the magnetic field strength at each laser light exposure position Li (i=1 to n) is obtained, so that the magnetic field strength distribution is obtained.

This method produces the same effects as in the first embodiment. Further, according to this method, since the relationship between coercive force and temperature is employed, it is possible to perform conversion into magnetic field strength with more accuracy, so that a highly accurate magnetic field strength distribution is obtained.

In the second embodiment, it is also possible to further perform measurement of the position of the magnetic sensing part of a reproduction element shown in FIG. 9. In this case, the measurement flow shown in FIG. 9 may be performed after measurement of reproduction output in step S154 of FIG. 14. As a result, it is possible to measure the position of the magnetic sensing part of a reproduction element with good accuracy.

### Third Embodiment

According to a method of manufacturing a magnetic head according to a third embodiment of the present invention, the method of measuring the magnetic field strength distribution of a magnetic head according to the first or second embodiment is applied to a magnetic head testing process.

The magnetic head manufacturing process includes an element part forming process of forming reproduction elements and recording elements on a wafer, a flying surface forming process of forming a flying surface on each of strip-shaped row bars into which the wafer is cut, an assembling process of cutting each row bar into individual head sliders and fixing the head sliders to suspensions, and a testing process.

Referring back to FIG. 2, the process of testing the magnetic head 11 is performed after the process of assembling the suspension 31 and the head slider 34 of the magnetic head 11. In the testing process, it is determined whether the strength distribution of a magnetic field generated from a recording element at a predetermined recording current value falls within the range of a magnetic field strength distribution serving as a reference. If the strength distribution of the generated magnetic field falls within the range, the magnetic head 11 is determined as acceptable. If the strength distribution of the generated magnetic field falls out of the range, the magnetic head 11 is rejected as a defective product. A detailed description is given below of the testing process.

This test employs the measurement apparatus 10 of the first embodiment shown in FIG. 1. According to this test, steps S102 through S116, which are part of the flowchart shown in FIG. 6, are performed. The obtained relationship between the reproduction output and the positions on the medium recording surface is compared with a reference relationship between the reproduction output and the positions on the medium recording surface within a predetermined range, and it is determined whether the obtained relationship between the reproduction output and the positions on the medium recording surface is within the range. If the obtained relationship between the reproduction output and the positions on the medium recording surface is within the range, the magnetic head 11 is determined as acceptable. If the obtained relationship between the reproduction output and the positions on the medium recording surface is out of the range, the magnetic head 11 is rejected as a defective product. In this test, the conversion into magnetic strength of step S118 of FIG. 6 may be omitted since it is sufficient to sort acceptable magnetic heads from defective magnetic heads.

Still, it is possible to perform all the steps of the flowchart of FIG. 6 except step S134 and obtain the recording magnetic field strength distribution of a test-target magnetic head, thereby determining whether the obtained recording magnetic field strength distribution is within a reference magnetic field strength distribution (serving as a reference).

As an alternative test, it is possible to perform all the steps of the flowchart of FIG. 14 except step S134 and obtain a recording magnetic field strength distribution, and sort the good (acceptable) from the defective by determining whether the obtained recording magnetic field strength distribution is within a reference magnetic field strength distribution.

Further, in addition to the above-described test or alternative test, the measurement of the position of the magnetic sensing part of a reproduction element described with reference to FIGS. 6 and 9 through 11 may be performed as a test item. Then, it may be determined whether the obtained position of the magnetic sensing part of the reproduction element is within a predetermined range, thereby sorting the good from the defective.

According to the manufacturing method of the third embodiment, it is determined whether a magnetic head is acceptable or not by indirectly or directly measuring its magnetic field strength distribution with a simple method. Accordingly, it is possible to manufacture a highly reliable magnetic head.

According to one embodiment of the present invention, there is provided a method of measuring the recording magnetic field strength distribution of a magnetic head having a recording element, the method including the steps of: (a) disposing the magnetic head at a distance from and above a measurement medium having a recording layer; (b) heating one of partial areas of the recording layer which areas oppose a medium-opposing surface of the recording element, and generating a recording magnetic field to emanate from the recording element by supplying a predetermined recording current to the recording element; (c) measuring the reproduction output of a magnetic track formed in the one of the partial areas; (d) repeating steps (b) and (c) while changing the one of the partial areas to be heated; and (e) converting the reproduction outputs obtained for the partial areas into the recording magnetic field strength distribution, wherein the one of the partial areas corresponds to a part of the medium-opposing surface of the recording element; the coercive force of the measurement medium is reduced by the heating; and step (b) heats the one of the partial areas of the recording layer to a temperature at which the coercive force of the measurement medium is lower than the strength of the magnetic field applied to the one of the partial areas from the magnetic head.

According to one embodiment of the present invention, a measurement medium is employed which, at room temperature, has a coercive force higher than the maximum recording magnetic field strength of a magnetic head to be subjected to measurement at a predetermined recording current. Then, a partial area of the recording layer of the measurement medium corresponding to a part of the medium-opposing surface of the recording element of the magnetic head is heated, so that the coercive force of the recording layer is lower in the heated area than in the other area of the recording layer. As a result, only the heated partial area is magnetized with a recording magnetic field emanating from the magnetic head, so that a magnetic track is formed therein. The reproduction output of the magnetic track is measured and converted into magnetic field strength, so that the magnetic field strength of the recording magnetic field can be detected. Further, by measuring the reproduction output corresponding to multiple laser light exposure positions while changing the position to be exposed to laser light, it is possible to determine the recording magnetic field strength distribution of the magnetic head. Accordingly, it is possible to measure magnetic field strength distribution with a simple method.

According to one embodiment of the present invention, there is provided an apparatus for measuring the recording magnetic field strength distribution of a magnetic head having a recording element, the apparatus including: a positioning part configured to position the magnetic head; a measurement medium having a substrate and a recording layer on the substrate; a heating part configured to heat the measurement medium and be capable of scanning positions to be heated; a recording part configured to form a magnetic track in the recording layer by causing the recording element to generate a recording magnetic field with one of partial areas of the recording layer corresponding to a part of the medium-opposing surface of the recording element being heated to a predetermined temperature with the heating part; a reproduction output measurement part configured to measure the reproduction output of the magnetic track; and an operation part configured to convert the reproduction output into recording magnetic field strength, wherein the coercive force of the measurement medium is reduced by the heating; and the coercive force of the measurement medium is lower than the strength of the magnetic field applied to the one of the partial areas from the magnetic head at the predetermined temperature.

According to one embodiment of the present invention, it is possible to provide a measurement apparatus capable of performing the above-described method of measuring the recording magnetic field strength distribution of a magnetic head.

According to one embodiment of the present invention, there is provided a method of manufacturing a magnetic head having a recording element, the method including a test process of testing the magnetic head, wherein the test process includes the steps of: (a) disposing the magnetic head at a distance from and above a measurement medium having a recording layer; (b) heating one of partial areas of the recording layer which areas oppose the medium-opposing surface of the recording element, and generating a recording magnetic field to emanate from the recording element by supplying a predetermined recording current to the recording element; (c) measuring the reproduction output of a magnetic track formed in the one of the partial areas; (d) repeating steps (b) and (c) while changing the one of the partial areas to be heated; (e) converting the reproduction outputs obtained for the partial areas into the recording magnetic field strength distribution; and (f) comparing positions at which the recording magnetic fields are generated or recording magnetic field strengths at the positions with a predetermined range, and determining the magnetic head as an acceptable product if the positions at which the recording magnetic fields are generated or the recording magnetic field strengths at the positions are within the predetermined range and determining the magnetic head as a defective product if the positions at which the recording magnetic fields are generated or the recording magnetic field strengths at the positions are out of the predetermined range, wherein the one of the partial areas corresponds to a part of the medium-opposing surface of the recording element; the coercive force of the measurement medium is reduced by the heating; and step (b) heats the one of the partial areas of the recording layer at a temperature at which the coercive force of the measurement medium is lower than the strength of the magnetic field applied to the one of the partial areas from the magnetic head.

According to one embodiment of the present invention, it is possible to provide a method of manufacturing a magnetic head which method can detect the recording magnetic field strength distribution of a magnetic head to be subjected to measurement with a simple method without damaging the magnetic head.

Thus, according to embodiments of the present invention, it is possible to provide a method and apparatus for measuring the recording magnetic field strength distribution of a magnetic head and a method of manufacturing a magnetic head that can measure the recording magnetic field strength distribution of the magnetic head with ease and good measurement accuracy.

The present invention is not limited to the specifically disclosed embodiments, and variations and modifications may be made without departing from the scope of the present invention.

For example, the reproduction head 60 is used to measure the reproduction output of a track in the measurement apparatus 10 shown in FIG. 1. This reproduction head 60 may be replaced by a probe-type element such as a magnetic force microscope (MFM). In this case, magnetic field strength on the surface of a measurement medium is determined instead of reproduction output. As a result, a magnetic field strength-laser light exposure position relationship that is the same as, for example, the reproduction output-laser light exposure position relationship shown in FIG. 8A is obtained.

The present application is based on Japanese Priority Patent Application No. 2006-269638, filed on Sep. 29, 2006, the entire contents of which are hereby incorporated by reference.

What is claimed is:

1. A method of measuring a recording magnetic field strength distribution of a magnetic head having a recording element, the method comprising the steps of:
(a) disposing the magnetic head at a distance from and above a measurement medium having a recording layer;
(b) heating one of partial areas of the recording layer which areas oppose a medium-opposing surface of the recording element, and generating a recording magnetic field to emanate from the recording element by supplying a predetermined recording current to the recording element;
(c) measuring a reproduction output of a magnetic track formed in the one of the partial areas;
(d) repeating said steps (b) and (c) while changing the one of the partial areas to be heated; and
(e) converting the reproduction outputs obtained for the partial areas into the recording magnetic field strength distribution,
wherein the one of the partial areas corresponds to a part of the medium-opposing surface of the recording element;
a coercive force of the measurement medium is reduced by the heating; and
said step (b) heats the one of the partial areas of the recording layer to a temperature at which the coercive force of the measurement medium is lower than a strength of the magnetic field applied to the one of the partial areas from the magnetic head.

2. The method as claimed in claim 1, wherein said step (b) heats the one of the partial areas of the recording layer by emitting laser light thereonto.

3. The method as claimed in claim 1, wherein:
the measurement medium includes a substrate transmitting laser light and the recording layer formed on the substrate; and
the laser light is emitted from a side of the measurement medium opposite to the magnetic head so as to pass through the substrate of the measurement medium.

4. The method as claimed in claim 1, wherein the coercive force of the measurement medium is higher than a maximum strength of the recording magnetic field generated by the recording element in accordance with the predetermined recording current when the measurement medium is not heated.

5. The method as claimed in claim 1, wherein:
said step (b) heats the one of the partial areas of the recording layer by emitting laser light thereonto; and
the laser light has a spot size of 0.9 μm or less.

6. The method as claimed in claim 1, wherein said step (c) measures the reproduction output by causing a reproduction element of a reproduction head to coincide with a position of the magnetic track.

7. The method as claimed in claim 1, wherein said step (c) measures a profile of the reproduction output while moving a reproduction element in a direction of a width of the magnetic track, and determines a maximum value of the profile finally as the reproduction output.

8. The method as claimed in claim 1, wherein:
the recording element includes a first magnetic pole, a magnetic gap part, and a second magnetic pole disposed in this order; and
said step (d) sets the one of the partial areas in an area of the measurement medium-opposing an area extending from the first magnetic pole to the second magnetic pole through the magnetic gap part.

9. The method as claimed in claim 1, wherein:
said step (b) heats the one of the partial areas of the recording layer by emitting laser light thereonto; and
said step (d) changes the one of the partial areas to be heated by fixing a position of the magnetic head and changing a position exposed to the laser light.

10. The method as claimed in claim 1, wherein the magnetic head further includes a reproduction element,
the method further comprising the steps of:
(f) measuring a different reproduction output of the one of the partial areas with the reproduction element of the magnetic head while emitting laser light of a predetermined laser power onto the one of the partial areas after said step (c); and
(g) determining a position corresponding to one of the partial areas which one has a minimum one of the different reproduction outputs of the partial areas, and determining the position as a position of the reproduction element of the magnetic head after said step (e),
wherein said step (d) performs said steps (b), (c), and (f) while changing the one of the partial areas to be heated.

11. The method as claimed in claim 10, wherein the predetermined laser power is determined so as to heat the one of the partial areas to a temperature at which a magnetization of the one of the partial areas is reduced.

12. The method as claimed in claim 1, wherein the magnetic head further includes a reproduction element, the method further comprising the steps of:
(f) performing recording on an area of the recording layer opposing the reproduction element with the recording element;
(g) measuring a reproduction output of the area with the reproduction element of the magnetic head while emitting laser light of a predetermined laser power onto the area; and
(h) determining a position corresponding to a part of the area at which part the reproduction output of the area is minimized, and determining the position as a position of the reproduction element of the magnetic head,
wherein said steps (f), (g), and (h) are performed after said step (d).

13. The method as claimed in claim 12, wherein the predetermined laser power is determined so as to heat the area of the recording layer to a temperature at which a magnetization of the one of the partial areas is reduced.

14. The method as claimed in claim 1, further comprising the step of performing said steps (b) and (c) while changing a temperature to which the one of the partial areas of the recording layer is heated, and determining a temperature at which the reproduction output starts to appear after said step (c),
wherein said step (e) converts the temperature at which the reproduction output starts to appear into a coercive force value based on a relationship between the temperature and the coercive force of the measurement medium, and determines the coercive force value as a magnetic field strength.

15. The method as claimed in claim 14, wherein the coercive force of the measurement medium and the temperature have a linear relationship around the temperature at which the reproduction output starts to appear.

16. The method as claimed in claim 1, wherein:
the recording element of the magnetic head includes a main magnetic pole and an auxiliary magnetic pole; and
the measurement medium includes a substrate, a soft magnetic underlayer formed of a soft magnetic material on the substrate, and the recording layer formed of a perpendicular magnetization film on the soft magnetic underlayer.

17. An apparatus for measuring a recording magnetic field strength distribution of a magnetic head having a recording element, the apparatus comprising:
a positioning part configured to position the magnetic head;
a measurement medium having a substrate and a recording layer on the substrate;
a heating part configured to heat the measurement medium and be capable of scanning positions to be heated;
a recording part configured to form a magnetic track in the recording layer by causing the recording element to generate a recording magnetic field with one of partial areas of the recording layer corresponding to a part of a medium-opposing surface of the recording element being heated to a predetermined temperature with the heating part;
a reproduction output measurement part configured to measure a reproduction output of the magnetic track; and
an operation part configured to convert the reproduction output into a recording magnetic field strength,
wherein:
a coercive force of the measurement medium is reduced by the heating; and
the coercive force of the measurement medium is lower than a strength of the magnetic field applied to the one of the partial areas from the magnetic head at the predetermined temperature.

18. The apparatus as claimed in claim 17, wherein the heating part comprises:
a laser light emission part configured to emit laser light onto the measurement medium; and
an exposure position control part configured to be capable of scanning positions exposed to the laser light.

19. The apparatus as claimed in claim 18, wherein the laser light emission part is disposed on a substrate side of the measurement medium so as to heat the recording layer by causing the laser light to pass through the substrate.

20. The apparatus as claimed in claim 18, wherein the laser light emission part forms a laser spot of 0.9 μm or less in spot size on a surface of the measurement medium exposed to the laser light.

21. The apparatus as claimed in claim 17, wherein the coercive force of the measurement medium is higher than a maximum strength of the recording magnetic field generated by the recording element in accordance with a predetermined recording current when the measurement medium is not heated.

22. A method of manufacturing a magnetic head having a recording element, the method including a test process of testing the magnetic head, wherein the test process comprises the steps of:
(a) disposing the magnetic head at a distance from and above a measurement medium having a recording layer;
(b) heating one of partial areas of the recording layer which areas oppose a medium-opposing surface of the recording element, and generating a recording magnetic field to emanate from the recording element by supplying a predetermined recording current to the recording element;
(c) measuring a reproduction output of a magnetic track formed in the one of the partial areas;
(d) repeating said steps (b) and (c) while changing the one of the partial areas to be heated;
(e) converting the reproduction outputs obtained for the partial areas into the recording magnetic field strength distribution; and
(f) comparing positions at which the recording magnetic fields are generated or recording magnetic field strengths at the positions with a predetermined range, and determining the magnetic head as an acceptable product if the positions at which the recording magnetic fields are generated or the recording magnetic field strengths at the positions are within the predetermined range and determining the magnetic head as a defective product if the positions at which the recording magnetic fields are generated or the recording magnetic field strengths at the positions are out of the predetermined range,
wherein the one of the partial areas corresponds to a part of the medium-opposing surface of the recording element;
a coercive force of the measurement medium is reduced by the heating; and
said step (b) heats the one of the partial areas of the recording layer to a temperature at which the coercive force of the measurement medium is lower than a strength of the magnetic field applied to the one of the partial areas from the magnetic head.

23. The method as claimed in claim 22, wherein said step (b) heats the one of the partial areas of the recording layer by emitting laser light thereonto.

24. The method as claimed in claim 22, wherein said step (c) measures the reproduction output by causing a reproduction element of a reproduction head to coincide with a position of the magnetic track.

25. The method as claimed in claim 22, wherein:
said step (b) heats the one of the partial areas of the recording layer by emitting laser light thereonto; and
said step (d) changes the one of the partial areas to be heated by fixing a position of the magnetic head and changing a position exposed to the laser light.

26. The method as claimed in claim 22, wherein the magnetic head further includes a reproduction element,
the method further comprising the steps of:
(g) measuring a different reproduction output of the one of the partial areas with the reproduction element of the magnetic head while emitting laser light of a predetermined laser power onto the one of the partial areas between said steps (c) and (d); and
(h) determining a position corresponding to one of the partial areas which one has a minimum one of the different reproduction outputs of the partial areas, and determining the position as a position of the reproduction element of the magnetic head after said step (e),
wherein said step (f) compares the position of the reproduction element with a predetermined range, and further determines the magnetic head as an acceptable product if the position of the reproduction element is within the predetermined range and determines the magnetic head as a defective product if the position of the reproduction element is out of the predetermined range.
